(19) United States
(12) Patent Application Publication
(10) Pub. No.: US 2025/0106827 A1
(43) Pub. Date: Mar. 27, 2025

(54) METHOD AND DEVICE IN NODES USED FOR WIRELESS COMMUNICATION

(71) Applicants: Qi JIANG, Shanghai (CN); Ping WANG, Shanghai (CN); Xiaobo ZHANG, Shanghai (CN)

(72) Inventors: Qi JIANG, Shanghai (CN); Ping WANG, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/889,434

(22) Filed: Sep. 19, 2024

(30) Foreign Application Priority Data
Sep. 22, 2023 (CN) 202311235883.X

(51) Int. Cl. H04W 72/0446; H04B 7/04

(52) U.S. Cl. CPC H04W 72/0446; H04B 7/04013

(57) ABSTRACT

A first node receives a first reference signal in a first RS resource; first operates a first signal on a first frequency band; a duplex mode of the first frequency band is a frequency division duplex; the first operating is to receive and the first signal is on a downlink working band, or the first operating is to transmit and the first signal is on an uplink working band; the first signal is spatially associated with the first RS resource; when the first operating is to receive, time-domain resources occupied by the first signal are not overlapping with a first time-domain resource pool; when the first operating is to transmit, time-domain resources occupied by the first signal are not overlapping with a second time-domain resource pool; time-domain resources occupied by the first time-domain resource pool are orthogonal to time-domain resources occupied by the second time-domain resource pool.

### CROSS REFERENCE TO RELATED APPLICATIONS

The present application claims the priority benefit of Chinese Patent Application No. 202311235883.X, filed on September 22,2023, the full disclosure of which is incorporated herein by reference.

### BACKGROUND

### Technical Field

The present application relates to transmission methods and devices in wireless communication systems, and in particular to a method and device for transmission of a radio signal in a wireless communication system supporting cellular networks.

### Related Art

In 2020, 5.5G industry vision for 5G evolution was first presented by the industry. In April 2021, 3GPP (3rd Generation Partner Project) officially identified 5.5G name of 5G evolution as 5G-Advanced, started the standardization process, and planned to define 5G-Advanced technical specifications through Rel-18 (Release-18), Rel-19 and Rel-20. At the end of 2021, the first 28 topics of Rel-18 were set up, and the research and standardization of 5.5G technology entered a substantial stage. Future Rel-19 and Rel-20 will further explore new 5G-Advanced services and architectures.

Reconfigurable Intelligent Surface (RIS) is an artificial electromagnetic surface structure with programmable electromagnetic properties, containing a large number of independent low-cost passive subwavelength resonant units. Each RIS unit has an independent electromagnetic wave modulation capability, and the response of each unit to the radio signal can be controlled by changing parameters of the RIS unit, spatial distribution, etc., such as phase, amplitude, and polarization. Through the mutual superposition of the radio response signals of a large number of RIS units, specific beam propagation properties are formed on the macro level, thus forming a flexible and controllable shaped beam to achieve the effect of eliminating the coverage blind zones, enhancing the edge coverage and increasing the rank of the multi-stream transmission. RIS technology is characterized by low cost, low energy consumption, programmability, ease of deployment, and high shaping gain with larger antenna scale, which is regarded as a key technology for research in the 5G-Advanced phase and one of the core visions for 6G.

### SUMMARY

In the existing standards, whether it is a time division duplex or frequency division duplex system, after transmission and reception of link calibration of the UE is completed, the uplink transmitting beam can be determined according to the downlink receiving beam based on a spatial relation between downlink reception and uplink transmission. However, since the uplink and downlink in a frequency division duplex system use different frequency bands for communications at the same moment, and the RIS can only perform beamforming for a specific beam direction at each moment, the spatial relation between the downlink reception and the uplink transmission of the UE in the RIS coverage in a frequency division duplex scenario may be different from the conventional scenario without introducing the RIS, and the traditional way of determining the uplink spatial transmission parameters by the spatial receiving parameters of the downlink reference signal may no longer be applicable.

To address the above problem, the present application provides a solution. It should be noted that NR (New Radio) system is used as an example in response to the above problem description, and the present application is equally applicable to, for example, a scenario of a future 6G system, to achieve technical effects similar to that of the NR system; further, while the present application was originally intended for RIS scenarios, the present application can be applied to other non-RIS scenarios as well; further, for different scenarios (e.g., other non-RIS scenarios including, but not limited to, capacity enhancement systems, systems for proximity communications, unlicensed spectrum communications, IoT (Internet of Things), URLLC (Ultra Reliable Low Latency Communication) network, Internet of Vehicles (IoV), etc.), adopting a unified design scheme also helps reduce hardware complexity and cost. If no conflict is incurred, embodiments in any node in the present application and the characteristics of the embodiments are also applicable to any other node, and vice versa. And the embodiments in the present application and the characteristics in the embodiments can be arbitrarily combined if there is no conflict.

Particularly, for interpretations of the terminology; nouns, functions and variants (if not specified) in the present application, refer to definitions given in TS38 series and TS37 series of 3GPP specifications. Where required, reference may be made to 3GPP standards TS38.211, TS38.212, TS38.213, TS38.214, TS38.215,TS38.300, TS38.304, TS38.305, TS38.321, TS38.331, TS37.355, TS38.423, to aid in the understanding of the present application.

In one embodiment, interpretations of the terminology in the present application refer to definitions given in 3GPP TS38 series.

In one embodiment, interpretations of the terminology in the present application refer to definitions given in 3GPP TS37 series.

The present application provides a method in a first node for wireless communications, comprising:

receiving a first reference signal in a first RS resource; and

first operating a first signal on a first frequency band;

herein, a duplex mode of the first frequency band is a frequency division duplex; the first operating is to receive and the first signal is on a downlink working band, or the first operating is to transmit and the first signal is on an uplink working band; the first signal is spatially associated with the first RS resource; when the first operating is to receive, time-domain resources occupied by the first signal are not overlapping with a first time-domain resource pool; when the first operating is to transmit, time-domain resources occupied by the first signal are not overlapping with a second time-domain resource pool; time-domain resources occupied by the first time-domain resource pool are orthogonal to time-domain resources occupied by the second time-domain resource pool.

In one embodiment, a problem to be solved in the present application comprises: how the first node receives or transmits the first signal in a frequency division duplex scenario.

In one embodiment, a problem to be solved in the present application comprises: in a frequency division duplex scenario, how the first node determines time-domain resources occupied for receiving or transmitting the first signal.

In one embodiment, corresponding problems of the above methods include: when the base station improves cell coverage through RIS, the spatial relation between downlink reception and uplink transmission of the UE under RIS coverage in the frequency division duplex scenario may be different from the traditional scenario without RIS, and the traditional method of determining uplink spatial transmission parameters through downlink spatial reception parameters may no longer be applicable.

In one embodiment, characteristics of the above method comprise: when the spatial relation of the first signal is associated with a first RS resource, the present application introduces a first time-domain resource pool and a second time-domain resource pool to ensure that the first node occupies orthogonal time-domain resources when transmitting or receiving the first signal, so that RIS can perform beamforming for specific uplink and downlink directions under specific time-domain resources, thereby solving the above problems.

In one embodiment, characteristics of the above method comprise: the first time-domain resource pool is not used for downlink transmission, and the second time-domain resource pool is not used for uplink transmission.

In one embodiment, characteristics of the above method comprise: the first RS resource is used for determining the downlink coverage and uplink transmission related information of terminals within the RIS coverage.

In one embodiment, characteristics of the above method comprise: both the base station and the UE side support beam reciprocity.

In one embodiment, advantages of the above method comprise: the present application supports RIS technology, which has the advantages of eliminating coverage blind spots, enhancing edge coverage, and increasing the rank of multi-stream transmission.

In one embodiment, advantages of the above method comprise: improving the reliability of uplink transmission.

In one embodiment, advantages of the above method comprise: being able to optimize system parameters, beam shape, and direction only for downlink or uplink at specific times when configuring RIS.

In one embodiment, advantages of the above method comprise: helping to solve the problem of inconsistent coverage areas in uplink and downlink of RIS in frequency-division multiplexing scenarios, improving overall system performance, and enhancing user experience, especially for boundary users.

According to one aspect of the present application, the above method is characterized in comprising:

receiving a first signaling, the first signaling indicating a first RS resource set;

herein, only when the first RS resource is an RS resource in the first RS resource set, the first time-domain resource pool and the second time-domain resource pool are applied.

In one embodiment, characteristics of the above method comprise: the first signaling implicitly indicates whether the first time-domain resource pool and the second time-domain resource pool are applied.

In one embodiment, characteristics of the above method comprise: any RS resource in the first RS resource set is used for determining the downlink coverage and uplink transmission related information of terminals within the RIS coverage.

In one embodiment, advantages of the above method comprise: by configuring a time-domain resource pool for RS resources in a specific RS resource set, the resource allocation between the uplink and downlink can be dynamically adjusted according to the interference situation, making the system better adapt to communication demand changes in different regions and time periods, thus improving the flexibility and efficiency of the system.

In one embodiment, advantages of the above method comprise: effectively managing interference and improving overall network quality while saving spectrum resources.

In one embodiment, advantages of the above method comprise: simplifying the system design and having good backward compatibility.

According to one aspect of the present application, the above method is characterized in that when the first operating is to receive, the time-domain resources occupied by the first signal belong to a second time-domain resource set; when the first operating is to transmit, the time-domain resources occupied by the first signal belong to a first time-domain resource set; the first time-domain resource pool comprises the first time-domain resource set, and the second time-domain resource pool comprises the second time-domain resource set.

In one embodiment, characteristics of the above method comprise: the first time-domain resource set is used for uplink transmission, and the second time-domain resource set is used for downlink transmission.

In one embodiment, characteristics of the above method comprise: the first time-domain resource set and the second time-domain resource set are orthogonal in time domain.

In one embodiment, characteristics of the above method comprise: there exists at least one time resource belonging to the first time-domain resource pool and not belonging to the first time-domain resource set, there exists at least one time resource belonging to the second time-domain resource pool and not belonging to the second time-domain resource set, the time resource comprising subframe, slot or multicarrier symbol.

In one embodiment, characteristics of the above method comprise: RIS optimizes beamforming parameters only for uplink transmission in time-domain resources comprised in the first time-domain resource set, and optimizes beamforming parameters only for downlink transmission in time-domain resources comprised in the second time-domain resource set.

In one embodiment, advantages of the above method comprise: reserving time for RIS parameter switching and reducing the requirements for RIS.

In one embodiment, advantages of the above method comprise: in the scenario of deploying RIS, the system adopts the time-division duplex approach for reference signal resources serving RIS to ensure correct transmission of both uplink and downlink.

In one embodiment, characteristics of the above method comprise: in the scenario of deploying RIS, for a given downlink beam, the base station needs to adopt an uplink beam that is not reciprocal to the downlink beam to ensure the reception performance, and then needs to adopt time-division duplex method to implement it.

In one embodiment, advantages of the above method comprise: simplifying the system and reducing deployment requirements for RIS cost.

In one embodiment, advantages of the above method comprise: improving the flexibility and efficiency of the system.

According to one aspect of the present application, the above method is characterized in comprising: receiving a second signaling;

herein, the second signaling is used to configure the first time-domain resource set and the second time-domain resource set.

In one embodiment, characteristics of the above method comprise: the second signaling is a broadcast signaling.

In one embodiment, characteristics of the above method comprise: the second signaling is cell-common.

In one embodiment, advantages of the above method comprise: facilitating system level resource scheduling and optimization.

In one embodiment, advantages of the above method comprise: reducing the complexity of terminal devices, simplifying operations of terminal devices, and facilitating centralized optimization and management of time-domain resources in the network.

According to one aspect of the present application, the above method is characterized in comprising:

receiving a third signaling;

herein, the third signaling is used to configure the first time-domain resource set and the second time-domain resource set, the second signaling is a higher-layer signaling, and the third signaling is a physical-layer signaling.

In one embodiment, characteristics of the above method comprise: the third signaling is unicast.

In one embodiment, characteristics of the above method comprise: the third signaling is UE-specific.

In one embodiment, advantages of the above method comprise: flexibly configuring the first time-domain resource set and the second time-domain resource set, which is conducive to adapting to rapidly changing environment.

In one embodiment, advantages of the above method comprise: dividing configurations of parameters for the first time-domain resource set and the second time-domain resource set into a higher-layer signaling and a physical layer can provide benefits such as flexibility, independence, distributed decision-making capabilities, and reduced complexity.

In one embodiment, advantages of the above method comprise: being conducive to optimizing system performance, improving resource utilization, and improving user experience.

According to one aspect of the present application, the above method is characterized in comprising:

receiving a fourth signaling;

herein, the fourth signaling is used to configure the first time-domain resource pool and the second time-domain resource pool.

In one embodiment, characteristics of the above method comprise: the fourth signaling is a broadcast signaling.

In one embodiment, characteristics of the above method comprise: the fourth signaling is cell-common.

In one embodiment, advantages of the above method comprise: facilitating adaptation to requirement change in different scenarios.

In one embodiment, advantages of the above method comprise: facilitating the combination of different network architectures to achieve a more efficient, scalable and manageable system.

According to one aspect of the present application, the above method is characterized in comprising:

receiving a second reference signal in a second RS resource; and

second operating a second signal on the first frequency band;

herein, the second operating is to receive and the second signal is on a downlink working band, or the second operating is to transmit and the second signal is on an uplink working band; the second signal is spatially associated with the second RS resource; the first time-domain resource pool and the second time-domain resource pool are not applied to the second RS resource.

In one embodiment, characteristics of the above method comprise: the second RS resource belongs to an RS resource outside the first RS resource set.

In one embodiment, characteristics of the above method comprise: the second RS resource is used for determining the downlink coverage and uplink transmission related information of terminals outside the RIS coverage.

In one embodiment, advantages of the above method comprise: parameter optimization can be performed only for specific beams when configuring RIS, which is beneficial for beam management and interference reduction.

In one embodiment, advantages of the above method comprise: simplifying the system design and having good backward compatibility.

According to one aspect of the present application, the above method is characterized in that the first node is a UE.

According to one aspect of the present application, the above method is characterized in that the first node is a relay node.

The present application provides a method in a second node for wireless communications, comprising:

transmitting a first reference signal in a first RS resource; and

third operating a first signal on a first frequency band;

herein, a duplex mode of the first frequency band is a frequency division duplex; the third operating is to transmit and the first signal is on a downlink working band, or the third operating is to receive and the first signal is on an uplink working band; the first signal is spatially associated with the first RS resource; when the third operating is to transmit, time-domain resources occupied by the first signal are not overlapping with a first time-domain resource pool; when the third operating is to receive, time-domain resources occupied by the first signal are not overlapping with a second time-domain resource pool; time-domain resources occupied by the first time-domain resource pool are orthogonal to time-domain resources occupied by the second time-domain resource pool.

According to one aspect of the present application, the above method is characterized in comprising:

transmitting a first signaling, the first signaling indicating a first RS resource set;

herein, only when the first RS resource is an RS resource in the first RS resource set, the first time-domain resource pool and the second time-domain resource pool are applied.

According to one aspect of the present application, the above method is characterized in that when the third operating is to transmit, the time-domain resources occupied by the first signal belong to a second time-domain resource set; when the third operating is to receive, the time-domain resources occupied by the first signal belong to a first time-domain resource set; the first time-domain resource pool comprises the first time-domain resource set, and the second time-domain resource pool comprises the second time-domain resource set.

According to one aspect of the present application, the above method is characterized in comprising:

transmitting a second signaling;

herein, the second signaling is used to configure the first time-domain resource set and the second time-domain resource set.

According to one aspect of the present application, the above method is characterized in comprising:

transmitting a third signaling:

herein, the third signaling is used to configure the first time-domain resource set and the second time- domain resource set, the second signaling is a higher-layer signaling, and the third signaling is a physical-layer signaling.

According to one aspect of the present application, the above method is characterized in comprising:

transmitting a fourth signaling;

herein, the fourth signaling is used to configure the first time-domain resource pool and the second time-domain resource pool.

According to one aspect of the present application, the above method is characterized in comprising:

transmitting a second reference signal in a second RS resource; and

operating a second signal fourthly on the first frequency band;

herein, the fourth operation is to transmit and the second signal is on a downlink working band, or the fourth operation is to receive and the second signal is on an uplink working band; the second signal is spatially associated with the second RS resource; the first time-domain resource pool and the second time-domain resource pool are not applied to the second RS resource.

According to one aspect of the present application, the above method is characterized in that the second node is a base station.

According to one aspect of the present application, the above method is characterized in that the second node is a UE.

According to one aspect of the present application, the above method is characterized in that the second node is a serving cell.

According to one aspect of the present application, the above method is characterized in that the second node is a serving cell of the first node.

According to one aspect of the present application, the above method is characterized in that the second node is a relay node.

The present application provides a device in a first node for wireless communications, comprising:

a first receiver, receiving a first reference signal in a first RS resource; and

a first processor, first operating a first signal on a first frequency band;

herein, a duplex mode of the first frequency band is a frequency division duplex; the first operating is to receive and the first signal is on a downlink working band, or the first operating is to transmit and the first signal is on an uplink working band; the first signal is spatially associated with the first RS resource; when the first operating is to receive, time-domain resources occupied by the first signal are not overlapping with a first time-domain resource pool; when the first operating is to transmit, time-domain resources occupied by the first signal are not overlapping with a second time-domain resource pool; time-domain resources occupied by the first time-domain resource pool are orthogonal to time-domain resources occupied by the second time-domain resource pool.

The present application provides a device in a second node for wireless communications, comprising:

a first transmitter, transmitting a first reference signal in a first RS resource; and

a second processor, third operating a first signal on a first frequency band;

herein, a duplex mode of the first frequency band is a frequency division duplex; the third operating is to transmit and the first signal is on a downlink working band, or the third operating is to receive and the first signal is on an uplink working band; the first signal is spatially associated with the first RS resource; when the third operating is to transmit, time-domain resources occupied by the first signal are not overlapping with a first time-domain resource pool; when the third operating is to receive, time-domain resources occupied by the first signal are not overlapping with a second time-domain resource pool; time-domain resources occupied by the first time-domain resource pool are orthogonal to time-domain resources occupied by the second time-domain resource pool.

In one embodiment, compared to conventional solutions, the present application has the following favorable, but not limited, advantages;

supporting RIS technology; which has the advantages of eliminating coverage blind spots, enhancing edge coverage, and increasing rank through multi-stream transmission;

being able to optimize system parameters, beam shape, and direction only for downlink or uplink at specific times when configuring RIS;

helping to solve the problem of inconsistent uplink and downlink coverage areas that may occur in RIS in frequency division multiplexing scenarios, or scenarios in which the uplink and downlink beams are not reciprocal, thus improving the overall system performance, and improving the experience of the users, in particular, the boundary users;

enabling the system to better adapt to changes in communication needs in different regions and different time periods, thus improving the flexibility and efficiency of the system.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of transmission of a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a first flowchart of transmission between a first node and a second node according to one embodiment of the present application;

FIG. 6 illustrates a second flowchart of transmission between a first node and a second node according to one embodiment of the present application;

FIG. 7 illustrates a third flowchart of transmission between a first node and a second node according to one embodiment of the present application;

FIG. 8 illustrates a fourth flowchart of transmission between a first node and a second node according to one embodiment of the present application;

FIG. 9 illustrates a fifth flowchart of transmission between a first node and a second node according to one embodiment of the present application;

FIG. 10 illustrates a schematic diagram of a first time-domain resource pool, a second time-domain resource pool, a first time-domain resource set and a second time-domain resource set according to one embodiment of the present application;

FIG. 11 illustrates a schematic diagram of a Reconfigurable Intelligent Surface (RIS) according to one embodiment of the present application;

FIG. 12 illustrates a structure block diagram of a processor in a first node according to one embodiment of the present application;

FIG. 13 illustrates a structure block diagram of a processor in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart of transmission of a first node according to one embodiment of the present application, as shown in FIG. 1. In FIG. 1, each block represents a step, and in particular, the order of steps in the box does not represent a specific chronological relation between each step.

A first node receives a first reference signal in a first RS resource in step 101; and operates a first signal firstly on a first frequency band in step 102.

In embodiment 1, a duplex mode of the first frequency band is a frequency division duplex; the first operating is to receive and the first signal is on a downlink working band, or the first operating is to transmit and the first signal is on an uplink working band; the first signal is spatially associated with the first RS resource; when the first operating is to receive, time-domain resources occupied by the first signal are not overlapping with a first time-domain resource pool; when the first operating is to transmit, time-domain resources occupied by the first signal are not overlapping with a second time-domain resource pool; time-domain resources occupied by the first time-domain resource pool are orthogonal to time-domain resources occupied by the second time-domain resource pool.

In one embodiment, the RS refers to: Reference Signal.

In one embodiment, the first node receives the first reference signal in the first RS resource.

In one embodiment, the first RS resource is a resource occupied by at least a synchronization signal in a system after 5G system.

In one embodiment, the first RS resource is a resource occupied by at least a synchronization signal in 6G system.

In one embodiment, the first RS resource is a CSI-RS (Channel State Information Reference Signal) resource or SSB.

In one embodiment, the first RS resource is a CSI-RS resource.

In one embodiment, the first RS resource is an NZP (Non Zero Power) CSI-RS resource.

In one embodiment, the first RS resource corresponds to an RS resource Identity (Id).

In one embodiment, the RS resource identity in the present application is used to identify the RS resource.

In one embodiment, the RS resource identity in the present application is an index of the RS resource.

In one embodiment, the RS resource identity in the present application comprises a configuration index of the RS resource.

In one embodiment, the RS resource identity in the present application is a configuration index of the RS resource.

In one embodiment, the first RS resource corresponds to an NZP-CSI-RS-ResourceId.

In one embodiment, the first RS resource corresponds to a CSI-ResourceConfigId.

In one embodiment, the first RS resource corresponds to a CSI-RS resource set.

In one embodiment, the first RS resource corresponds to an NZP CSI-RS resource set.

In one embodiment, the first RS resource corresponds to an RS resource set identity.

In one embodiment, the RS resource set identity in the present application is used to identify the RS resource set.

In one embodiment, the RS resource set identity in the present application is an index of the RS resource set.

In one embodiment, the RS resource set identity in the present application comprises a configuration index of the RS resource set.

In one embodiment, the first RS resource corresponds to NZP-CSI-RS-ResourceSetId.

In one embodiment, the first RS resource is an SSB.

In one embodiment, the first RS resource corresponds to an SSB-Index.

In one embodiment, the first RS resource corresponds to an ssb-Index.

In one embodiment, the first RS resource comprises one or multiple ports.

In one subembodiment of the embodiment, the one or multiple antennas comprised in the first RS resource are respectively CSI-RS ports.

In one subembodiment of the embodiment, the one or multiple antennas comprised in the first RS resource are respectively antenna ports.

In one embodiment, the first RS resource comprises a reference signal.

In one embodiment, the first RS resource comprises a reference signal transmitted in the first RS resource.

In one embodiment, the first reference signal comprises a downlink reference signal.

In one embodiment, the first reference signal is a downlink reference signal.

In one embodiment, the first reference signal is a CSI-RS or an SSB.

In one embodiment, the first reference signal is a CSI-RS.

In one embodiment, the first reference signal is an SSB.

In one embodiment, the SSB in the present application refers to: a Synchronization Signal Block.

In one embodiment, the SSB in the present application refers to: an SS (Synchronization Signal)/PBCH (Physical Broadcast Channel) block.

Typically, reception occasions of PBCH, PSS (Primary Synchronization Signal), and SSS (Secondary Synchronization Signal) are in continuous symbols and form an SS/PBCH block.

In one embodiment, the first RS resource occupies at least one multicarrier symbol in time domain.

In one embodiment, the first RS resource occupies multiple continuous multicarrier symbols in time domain.

In one embodiment, the first RS resource occupies a slot in time domain.

In one embodiment, the first RS resource occupies a subframe in time domain.

In one embodiment, the first RS resource occupies at least one sub-band in frequency domain.

In one embodiment, the first RS resource occupies at least one RB (Resource Block) in frequency domain.

Typically, an RB occupies 12 continuous subcarriers in frequency domain.

In one embodiment, the first RS resource occupies a group of downlink PRBs (Physical Resource Blocks).

In one embodiment, the first RS resource occupies at least one RE (Resource Element).

Typically, an RE occupies a symbol in time domain and a subcarrier in frequency domain.

In one embodiment, the meaning of the characteristic of receiving a first reference signal on a first RS resource comprises: receiving the first reference signal in an RE corresponding to the first RS resource.

In one embodiment, the meaning of the characteristic of receiving a first reference signal on a first RS resource comprises: receiving the first reference signal based on power control parameters of the first RS resource.

In one embodiment, the meaning of the characteristic of receiving a first reference signal on a first RS resource comprises: receiving the first reference signal based on spatial reception parameters of the first RS resource.

In one embodiment, the meaning of the characteristic of receiving a first reference signal on a first RS resource comprises: receiving the first reference signal based on configuration information of the first RS resource.

In one embodiment, the Spatial Rx parameters in the present application comprise at least one of a receiving beam, a receiving analog beamforming matrix, a receiving analog beamforming vector, a receiving beamforming matrix, a receiving beamforming vector and a spatial-domain reception filter.

In one embodiment, configuration information of the reference signal resource in the present application comprises part or all of time-domain resources, frequency-domain resources, CDM (Code Division Multiplexing) type, scramblingID, period, QCL, density, number of port(s), cycle shift, OCC (Orthogonal Cover Code), transmission sequence, and TCI (Transmission Configuration Indicator).

In one embodiment, the QCL in the present application refers to: Quasi Co-Location.

In one embodiment, the QCL in the present application refers to: Quasi Co-Located.

In one embodiment, the QCL in the present application comprises a QCL parameter.

In one embodiment, the QCL in the present application comprises a QCL assumption.

In one embodiment, the QCL types in the present application comprise TypeA, TypeB, TypeC, and TypeD.

In one embodiment, QCL parameters with the QCL type of TypeA in the present application comprise Doppler shift, Doppler spread, average delay and delay spread; QCL parameters with the QCL type of TypeB comprise Doppler shift and Doppler spread; QCL parameters with the QCL type of TypeC comprise Doppler shift and average delay; QCL parameters with the QCL type of TypeD comprise spatial Rx parameter. In one embodiment, the QCL in the present application comprises at least one of Doppler shift, Doppler spread, average delay, delay spread, Spatial Tx parameter or Spatial Rx parameter.

In one embodiment, for specific definitions of the TypeA, the TypeB, the TypeC and the TypeD in the present application, refer to clause 5.1.5 in 3GPP TS 38.214.

In one embodiment, the first signal comprises a baseband signal.

In one embodiment, the first signal comprises a radio-frequency signal.

In one embodiment, the first signal comprises a radio signal.

In one embodiment, the first operating is to receive, and the first signal comprises a CSI-RS.

In one embodiment, the first operating is to receive, and the first signal comprises an SSB.

In one embodiment, the first operating is to receive, and the first signal comprises a PRS (Positioning Reference Signal).

In one embodiment, the first operating is to receive, and the first signal comprises a PTRS (Phase Tracking Reference Signal).

In one embodiment, the first operating is to receive, and the first signal comprises a TRS (Tracking Reference Signal).

In one embodiment, the first operating is to transmit, and the first signal comprises an SRS (Sounding Reference Signal).

In one embodiment, the first frequency band corresponds to a serving cell.

In one embodiment, the first frequency band comprises a carrier.

In one embodiment, the first frequency band comprises a CC (Component Carrier).

In one embodiment, the first frequency band corresponds to a BWP (Band Width Part).

In one embodiment, the first frequency band comprises a BWP.

In one embodiment, the first frequency band corresponds to an active BWP.

In one embodiment, the first frequency band comprises an active BWP.

In one embodiment, the first frequency band is identified by an operating band index.

In one embodiment, the first frequency band comprises a downlink operating band and an uplink operating band.

In one embodiment, the downlink working band is only used for downlink transmission.

In one embodiment, the uplink working band is only used for uplink transmission.

In one embodiment, the downlink working band occupies continuous frequency-domain resources.

In one embodiment, the uplink working band occupies continuous frequency-domain resources.

In one embodiment, frequency-domain resources occupied by the downlink working band and frequency-domain resources occupied by the uplink working band are orthogonal in frequency domain.

In one embodiment, frequency-domain resources occupied by the downlink working band and frequency-domain resources occupied by the uplink working band are not overlapping in frequency domain.

In one embodiment, for detailed definition of the working band in the present application, refer to clause 5 of 3GPP TS 38.101.

In one embodiment, a duplex mode adopted for a working band corresponding to the first frequency band is FDD.

In one embodiment, the FDD in the present application refers to: Frequency Division Duplex.

In one embodiment, the FDD in the present application refers to: Frequency Division Duplexing.

In one embodiment, the first operating is to receive and the first signal is on a downlink working band, or the first operating is to transmit and the first signal is on an uplink working band.

In one embodiment, the first operating is to receive and the first signal is on a downlink working band.

In one embodiment, the first operating is to transmit and the first signal is on an uplink working band.

In one embodiment, the first operating is to receive and frequency-domain resources occupied by the first signal belong to a downlink working band.

In one embodiment, the first operating is to transmit and frequency-domain resources occupied by the first signal belong to an uplink working band.

In one subembodiment of the above two embodiments, the first signal occupies continuous frequency- domain resources.

In one subembodiment of the above two embodiments, the first signal occupies discontinuous frequency-domain resources.

In one embodiment, the meaning of the characteristic that the first signal is spatially associated with the first RS resource comprises: the first signal and the first RS resource are QCLed.

In one embodiment, the meaning of the characteristic that the first signal is spatially associated with the first RS resource comprises: the first signal and a radio signal received in the first RS resource are QCLed.

In one embodiment, the meaning of the characteristic that the first signal is spatially associated with the first RS resource comprises: the first signal and a radio signal received in the first RS resource adopt a same spatial reception parameter.

In one embodiment, the meaning of the characteristic that the first signal is spatially associated with the first RS resource comprises: the first signal and a radio signal received in the first RS resource adopts a same receiving spatial filtering.

In one embodiment, the meaning of the characteristic that the first signal is spatially associated with the first RS resource comprises: the first signal and a radio signal received in the first RS resource adopt a same receiving spatial filtering parameter.

In one embodiment, the meaning of the characteristic that the first signal is spatially associated with the first RS resource comprises: the first operating is to receive, and the first RS resource is used to determine a spatial filtering of the first signal.

In one embodiment, the meaning of the characteristic that the first signal is spatially associated with the first RS resource comprises: the first operating is to receive, and a radio signal received in the first RS resource is used to determine a spatial filtering of the first signal.

In one embodiment, the meaning of the characteristic that the first signal is spatially associated with the first RS resource comprises: the first operating is to transmit, and the first RS resource is used to determine a spatial filtering of the first signal.

In one embodiment, the meaning of the characteristic that the first signal is spatially associated with the first RS resource comprises: the first operating is to transmit, and a radio signal received in the first RS resource is used to determine a spatial filtering of the first signal.

In one embodiment, the meaning of the characteristic that the first signal is spatially associated with the first RS resource comprises: the first operating is to receive, and a reception spatial filtering parameter of the first RS resource is used for a reception spatial filtering parameter of the first signal.

In one embodiment, the meaning of the characteristic that the first signal is spatially associated with the first RS resource comprises: the first operating is to receive, and a reception spatial filtering parameter of a radio signal received in the first RS resource is used for a reception spatial filtering parameter of the first signal.

In one embodiment, the meaning of the characteristic that the first signal is spatially associated with the first RS resource comprises: the first operating is to transmit, and a reception spatial filtering parameter of the first RS resource is used for a transmission spatial filtering parameter of the first signal.

In one embodiment, the meaning of the characteristic that the first signal is spatially associated with the first RS resource comprises: the first operating is to transmit, and a reception spatial filtering parameter of a radio signal received in the first RS resource is used for a transmission spatial filtering parameter of the first signal.

In one embodiment, the meaning of the characteristic that the first signal is spatially associated with the first RS resource comprises: the first operating is to receive, and the first RS resource is used to determine a DL RX Spatial Filter (DownLink Reception Spatial Filter) of the first signal.

In one embodiment, the meaning of the characteristic that the first signal is spatially associated with the first RS resource comprises: the first operating is to receive, and a radio signal received in the first RS resource is used to determine a DL RX Spatial Filter of the first signal.

In one embodiment, the meaning of the characteristic that the first signal is spatially associated with the first RS resource comprises: the first operating is to transmit, and the first RS resource is used to determine a UL TX Spatial Filter (UpLink Transmission Spatial Filter) of the first signal.

In one embodiment, the meaning of the characteristic that the first signal is spatially associated with the first RS resource comprises: the first operating is to transmit, and a radio signal received in the first RS resource is used to determine a UL TX Spatial Filter of the first signal.

In one embodiment, the meaning of the characteristic that the first signal is spatially associated with the first RS resource comprises: the first operating is to receive, and the first RS resource is used to determine spatial reception parameters of the first signal.

In one embodiment, the meaning of the characteristic that the first signal is spatially associated with the first RS resource comprises: the first operating is to receive, and a radio signal received in the first RS resource is used to determine a spatial reception parameter of the first signal.

In one embodiment, the meaning of the characteristic that the first signal is spatially associated with the first RS resource comprises: the first operating is to transmit, and the first RS resource is used to determine spatial transmission parameters of the first signal.

In one embodiment, the meaning of the characteristic that the first signal is spatially associated with the first RS resource comprises: the first operating is to transmit, and a radio signal received in the first RS resource is used to determine spatial transmission parameters of the first signal.

In one embodiment, the meaning of the characteristic that the first signal is spatially associated with the first RS resource comprises: the first operating is to receive, and the first node receives the first signal according to a spatial relation with reference to the first RS resource.

In one embodiment, the meaning of the characteristic that the first signal is spatially associated with the first RS resource comprises: the first operating is to receive, and the first node receives the first signal according to a spatial relation with reference to a radio signal received in the first RS resource.

In one embodiment, the meaning of the characteristic that the first signal is spatially associated with the first RS resource comprises: the first operating is to transmit, and the first node transmits the first signal according to a spatial relation with reference to the first RS resource.

In one embodiment, the meaning of the characteristic that the first signal is spatially associated with the first RS resource comprises: the first operating is to transmit, and the first node transmits the first signal according to a spatial relation with reference to a radio signal received in the first RS resource.

In one embodiment, the meaning of the characteristic that the first signal is spatially associated with the first RS resource comprises: the first operating is to receive, and PL (Pathloss) determined for the first RS resource is used to determine PL of the first signal.

In one embodiment, the meaning of the characteristic that the first signal is spatially associated with the first RS resource comprises: the first operating is to receive, and PL determined for a radio signal received in the first RS resource is used to determine PL of the first signal.

In one embodiment, the meaning of the characteristic that the first signal is spatially associated with the first RS resource comprises: the first operating is to transmit, and PL determined in the first RS resource is used to determine a transmit power value of the first signal.

In one embodiment, the meaning of the characteristic that the first signal is spatially associated with the first RS resource comprises: the first operating is to transmit, and PL determined for a radio signal received in the first RS resource is used to determine a transmit power value of the first signal.

In one embodiment, the meaning of the characteristic that the first signal is spatially associated with the first RS resource comprises: the first operating is to transmit, and a measurement for the first RS resource is used to determine a transmit power value of the first signal.

In one embodiment, the meaning of the characteristic that the first signal is spatially associated with the first RS resource comprises: the first operating is to transmit, and a measurement for a radio signal received in the first RS resource is used to determine a transmit power value of the first signal.

In one embodiment, the meaning of the characteristic that the first signal is spatially associated with

the first RS resource comprises: the first operating is to transmit, and a reception for a radio signal in the first RS resource is used to determine a downlink timing, and the downlink timing is used to determine a transmission timing of the first signal.

In one embodiment, a DMRS (DeModulation Reference Signal) antenna port of the first signal and an antenna port of the first RS resource are QCLed.

In one embodiment, an antenna port adopted by the first signal and an antenna port of the first RS resource are QCLed.

In one embodiment, when the first operating is to receive, time-domain resources occupied by the first signal are not overlapping with a first time-domain resource pool.

In one embodiment, the time-domain resources in the present application is a slot.

In one embodiment, the time-domain resources in the present application is a subframe.

In one embodiment, the time-domain resources in the present application is a multicarrier symbol.

In one embodiment, the time-domain resources in the present application comprise one or multiple slots.

In one embodiment, the time-domain resources in the present application comprise one or multiple subframes.

In one embodiment, the time-domain resources in the present application comprise one or multiple multicarrier symbols.

In one embodiment, the first signal occupies continuous time-domain resources in time domain.

In one embodiment, the first signal occupies discontinuous time-domain resources in time domain.

In one embodiment, the first signal occupies periodic time-domain resources in time domain.

In one embodiment, the time-domain resources occupied by the first signal comprise one or multiple subframes.

In one embodiment, the time-domain resources occupied by the first signal comprise one or multiple slots.

In one embodiment, the time-domain resources occupied by the first signal comprise one or multiple multicarrier symbols.

In one embodiment, the first time-domain resource pool comprises continuous time-domain resources.

In one embodiment, the first time-domain resource pool comprises discontinuous time-domain resources.

In one embodiment, the first time-domain resource pool comprises periodic time-domain resources.

In one embodiment, the first time-domain resource pool comprises multiple subframes.

In one embodiment, the first time-domain resource pool comprises multiple slots.

In one embodiment, the first time-domain resource pool comprises multiple multicarrier symbols.

In one embodiment, the multicarrier symbol in the present application is a Single Carrier-Frequency Division Multiple Access (SC-FDMA) symbol.

In one embodiment, the multicarrier symbol in the present application is a Filter Bank Multi Carrier (FBMC) symbol.

In one embodiment, the multicarrier symbol in the present application is an Orthogonal Frequency Division Multiplexing (OFDM) symbol.

In one embodiment, the symbol in the present application is obtained after an output of the transform pre-coder is through the OFDM symbol generation.

In one embodiment, the multicarrier symbol in the present application is a Discrete Fourier Transform-spread-OFDM (DFT-S-OFDM) symbol.

In one embodiment, the multicarrier symbol in the present application comprises a Cyclic Prefix (CP).

In one embodiment, the meaning of the characteristic that the time-domain resources occupied by the first signal are not overlapping with a first time-domain resource pool comprises: the time-domain resources occupied by the first signal are orthogonal to the first time-domain resource pool.

In one embodiment, the meaning of the characteristic that the time-domain resources occupied by the first signal are not overlapping with a first time-domain resource pool comprises: time-domain resources occupied by the first signal do not comprise the first time-domain resource pool.

In one embodiment, the meaning of the characteristic that the time-domain resources occupied by the first signal are not overlapping with a first time-domain resource pool comprises: the first signal does not occupy time-domain resources comprised in the first time-domain resource pool.

In one embodiment, the meaning of the characteristic that the time-domain resources occupied by the first signal are not overlapping with a first time-domain resource pool comprises: there is no time-domain resource that belongs to both the time-domain resource occupied by the first signal and the first time-domain resource pool at the same time.

In one embodiment, the second time-domain resource pool comprises continuous time-domain resources.

In one embodiment, the second time-domain resource pool comprises discontinuous time-domain resources.

In one embodiment, the second time-domain resource pool comprises periodic time-domain resources.

In one embodiment, the second time-domain resource pool comprises multiple slots.

In one embodiment, the second time-domain resource pool comprises multiple subframes.

In one embodiment, the second time-domain resource pool comprises multiple multicarrier symbols.

In one embodiment, the meaning of the characteristic that the time-domain resources occupied by the first signal are not overlapping with a second time-domain resource pool comprises: the time-domain resources occupied by the first signal are orthogonal to the second time-domain resource pool.

In one embodiment, the meaning of the characteristic that the time-domain resources occupied by the first signal are not overlapping with a second time-domain resource pool comprises: time-domain resources occupied by the first signal do not comprise the second time-domain resource pool.

In one embodiment, the meaning of the characteristic that the time-domain resources occupied by the first signal are not overlapping with a second time-domain resource pool comprises: the first signal does not occupy time-domain resources comprised in the second time-domain resource pool.

In one embodiment, the meaning of the characteristic that the time-domain resources occupied by the first signal are not overlapping with a second time-domain resource pool comprises: there is no time-domain resource that belongs to both the time-domain resource occupied by the first signal and the second time-domain resource pool at the same time.

In one embodiment, there is no subframe that does not belong to time-domain resources occupied by the first time-domain resource pool and does not belong to time-domain resources occupied by the second time-domain resource pool.

In one embodiment, there at least exists one subframe that does not belong to time-domain resources occupied by the first time-domain resource pool and does not belong to time-domain resources occupied by the second time-domain resource pool.

In one embodiment, there does not exist a slot not belonging to time-domain resources occupied by the first time-domain resource pool and not belonging to time-domain resources occupied by the second time-domain resource pool.

In one embodiment, there at least exists one slot that does not belong to time-domain resources occupied by the first time-domain resource pool and does not belong to time-domain resources occupied by the second time-domain resource pool.

In one embodiment, there does not exist a multicarrier symbol not belonging to time-domain resources occupied by the first time-domain resource pool and not belonging to time-domain resources occupied by the second time-domain resource pool.

In one embodiment, there exists at least one multicarrier symbol that does not belong to time-domain resources occupied by the first time-domain resource pool and does not belong to time-domain resources occupied by the second time-domain resource pool.

In one embodiment, the meaning of the characteristic that time-domain resources occupied by the first time-domain resource pool are orthogonal to time-domain resources occupied by the second time-domain resource pool comprises: time-domain resources occupied by the first time-domain resource pool and time-domain resources occupied by the second time-domain resource pool are not overlapping.

In one embodiment, the meaning of the characteristic that time-domain resources occupied by the first time-domain resource pool are orthogonal to time-domain resources occupied by the second time-domain resource pool comprises: there does not exist a subframe belonging to time-domain resources occupied by the first time-domain resource pool and time-domain resources occupied by the second time-domain resource pool at the same time.

In one embodiment, the meaning of the characteristic that time-domain resources occupied by the first time-domain resource pool are orthogonal to time-domain resources occupied by the second time-domain resource pool comprises: there does not exist a slot belonging to time-domain resources occupied by the first time-domain resource pool and time-domain resources occupied by the second time-domain resource pool at the same time.

In one embodiment, the meaning of the characteristic that time-domain resources occupied by the first time-domain resource pool are orthogonal to time-domain resources occupied by the second time-domain resource pool comprises: there does not exist a multicarrier symbol belonging to time-domain resources occupied by the first time-domain resource pool and time-domain resources occupied by the second time-domain resource pool at the same time.

### Embodiment 2

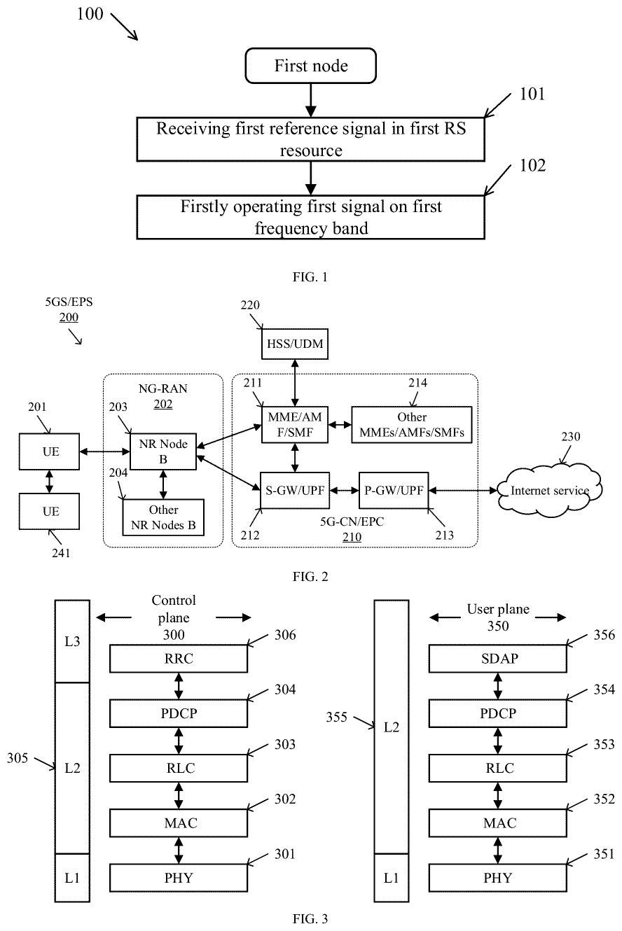

Embodiment 2 illustrates a schematic diagram of a network architecture according to one embodiment of the present application, as shown in FIG. 2.

FIG. 2 is a diagram illustrating a network architecture of Long-Term Evolution (LTE), Long-Term Evolution Advanced (LTE-A) and future 5G systems. The network architecture of the LTE, LTE-A and future 5G systems may be called an Evolved Packet System (EPS). The 5G NR or LTE network architecture may be called a 5G System (5GS)/Evolved Packet System (EPS) 200 or other appropriate terms. 5GS/EPS 200 may include one or more UEs 201, a UE 241 for sidelink communications with UE 201, NG-RAN (Next Generation Radio Access Network) 202, 5G-CN (5G Core Network)/EPC (Evolved Packet Core) 210, HSS (Home subscriber server)/UDM (Unified Data Management) 220, and Internet service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services. NG-RAN 202 comprises NR Node B (gNB) 203 and other gNBs 204. The gNB 203 provides UE 201-oriented user plane and control plane protocol terminations. The gNB 203 may connect to other gNBs 204 via an Xn interface (e.g., backhaul). The gNB 203 may also be referred to as a base station, base transceiver station, radio base station, radio transceiver, transceiver function, Basic Service Set (BSS), Extended Service Set (ESS), TRP (Transmitter Receiver Point), or some other suitable terms. The gNB 203 provides an access point for UE 201 to 5G-CN/EPC 210. Examples of the UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, game consoles, unmanned aerial vehicles (UAV), air vehicles, narrow-band physical network devices, machine-type communication devices, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy; a mobile client, a client or some other appropriate terms. The gNB 203 is connected to the 5G-CN/EPC 210 via an S1/NG interface. 5G-CN/EPC 210 includes MME (Mobility Management Entity)/AMF (Authentication Management Field)/SMF (Session Management Function) 211, other MMEs/AMFs/SMFs 214, S-GW (Service Gateway)/UPF (User Plane Function) 212, and P-GW (Packet Date Network Gateway)/UPF 213. The MME/AMF/SMF 211 is a control node for processing a signaling between the UE 201 and the 5G-CN/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. Internet Services 230 includes operator-corresponding Internet Protocol services, which may specifically include Internet, Intranet, IMS (IP Multimedia Subsystem) and packet switching services.

In one embodiment, the first node in the present application comprises the UE 201.

In one embodiment, the second node in the present application comprises the gNB 203.

In one embodiment, the UE 201 comprises a mobile phone.

In one embodiment, the UE 201 is a vehicle comprising a car.

In one embodiment, the gNB 203 is a Marco Cell base station.

In one embodiment, the gNB 203 is a Micro Cell base station.

In one embodiment, the gNB 203 is a Pico Cell base station.

In one embodiment, the gNB 203 is a Femtocell.

In one embodiment, the gNB 203 is a base station that supports large delay differences.

In one embodiment, the gNB 203 is a flight platform.

In one embodiment, the gNB 203 is satellite equipment.

In one embodiment, the gNB 203 is a test device (e.g., a transceiver device simulating partial functions of a base station, a signaling tester).

In one embodiment, a radio link from the UE 201 to the gNB 203 is an uplink, and the uplink is used for executing an uplink transmission.

In one embodiment, a radio link from the gNB 203 to the UE 201 is a downlink, and the downlink is used for executing a downlink transmission.

In one embodiment, a radio link between the UE 201 and the gNB 203 comprises a cellular network link.

In one embodiment, the UE 201 and the gNB 203 are connected via a Uu air interface.

In one embodiment, a transmitter of the first reference signal comprises the gNB 203.

In one embodiment, a receiver of the first reference signal comprises the UE 201.

In one embodiment, the first operating is to transmit, and a transmitter of the first signal comprises the UE 201.

In one embodiment, the first operating is to transmit, and a receiver of the first signal comprises the gNB 203.

In one embodiment, the first operating is to receive, and a transmitter of the first signal comprises the gNB 203.

In one embodiment, the first operating is to receive, and a receiver of the first signal comprises the UE 201.

In one embodiment, a transmitter of the first signaling comprises the gNB 203.

In one embodiment, a receiver of the first signaling comprises the UE 201.

In one embodiment, a transmitter of the second signaling comprises the gNB 203.

In one embodiment, a receiver of the second signaling comprises the UE 201.

In one embodiment, a transmitter of the third signaling comprises the gNB 203.

In one embodiment, a receiver of the third signaling comprises the UE 201.

In one embodiment, a transmitter of the fourth signaling comprises the gNB 203.

In one embodiment, a receiver of the fourth signaling comprises the UE 201.

In one embodiment, a transmitter of the second reference signal comprises the gNB 203.

In one embodiment, a receiver of the second reference signal comprises the UE 201.

In one embodiment, the second operation is to transmit, and a transmitter of the second signal comprises the UE 201.

In one embodiment, the second operation is to transmit, and a receiver of the second signal comprises the gNB 203.

In one embodiment, the second operation is to receive, and a transmitter of the second signal comprises the gNB 203.

In one embodiment, the second operation is to receive, and a receiver of the second signal comprises the UE 201.

In one embodiment, the UE 201 supports RIS (Reconfigurable Intelligent Surface).

In one embodiment, the gNB 203 supports RIS.

In one embodiment, the UE 201 supports FDD work.

In one embodiment, the gNB 203 supports FDD work.

### Embodiment 3

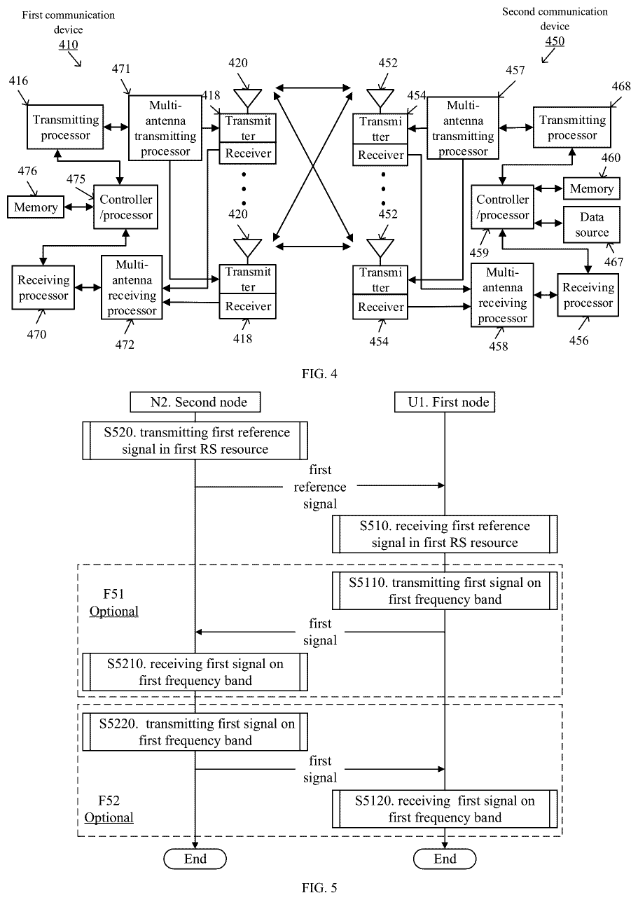

Embodiment 3 illustrates a schematic diagram of a radio protocol architecture of a user plane and a control plane according to one embodiment of the present application, as shown in FIG. 3.

FIG. 3 is a schematic diagram illustrating an embodiment of the radio protocol architecture for user plane 350 and control plane 300. FIG. 3 shows a radio protocol architecture for a first communication node device (UE or RSU (Road Side Unit) in V2X (Vehicle to Everything), vehicle-mounted device or vehicle-mounted communication module) and a second node device (gNB, UE or RSU in V2X, vehicle-mounted device or vehicle-mounted communication module), or the control plane 300 between two UEs in three layers: Layer 1 (L1), Layer 2 (L2) and Layer 3 (L3). L1 is the lowest layer and implements various PHY (physical layer) signal processing functions. L1 will be referred to as PHY 301 in this application. L2 305 is located above PHY 301 and is responsible for a link between the first node and the second node, or between two UEs, through the PHY 301. L2 305 includes MAC (Medium Access Control) sublayer 302, RLC (Radio Link Control) sublayer 303, and PDCP (Packet Data Convergence Protocol) sublayer 304, which terminate at the second node. The PDCP sublayer 304 provides multiplexing between different radio carriers and logical channels. The PDCP sublayer 304 provides security by encrypting a packet and provides support for a first communication node handover between second communication nodes. The RLC sublayer 303 provides segmentation and reassembling of an upper-layer packet, retransmission of a lost packet, and reordering of a packet so as to compensate the disordered reception incurred by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 includes Layer 1 (L1) and Layer 2 (L2), the radio protocol architecture for the first communication node device and the second communication node device in the user plane 350 is substantially the same for the physical layer 351, the PDCP sublayer 354 in L2 355, the RLC sublayer 353 in L2 355, and the MAC sublayer 352 in L2 355, as for the corresponding layers and sublayers in the control plane 300, but the PDCP sublayer 354 also provides header compression for upper layer packets to reduce radio transmission overhead. The L2 355 in the user plane 350 also includes Service Data Adaptation Protocol (SDAP) sublayer 356, which is responsible for the mapping between QoS (Quality of Service) flow and Data Radio Bearer (DRB) to support the diversity of traffic. Although not shown, the first communication node device may have several upper layers above the L2 355, including the network layer (e.g., IP (Internet Protocol) layer) terminating at the P-GW on the network side and an application layer terminating at the other end of the connection (e.g., remote UE, server, etc.).

In one embodiment, the radio protocol architecture in FIG. 3 is applicable to the first node in the

present application.

In one embodiment, the radio protocol architecture in FIG. 3 is applicable to the second node in the present application.

In one embodiment, the first reference signal is generated by the PHY 301 or the PHY 351.

In one embodiment, the first signal is generated by the PHY 301 or the PHY 351.

In one embodiment, the first signaling is generated by the RRC 306.

In one embodiment, the second signaling is generated by the RRC 306.

In one embodiment, the second signaling is generated by the MAC 302 or the MAC 352.

In one embodiment, the third signaling is generated by the PHY 301 or the PHY 351.

In one embodiment, the fourth signaling is generated by the RRC 306.

In one embodiment, the second reference signal is generated by the PHY 301 or the PHY 351.

In one embodiment, the second signal is generated by the PHY 301 or the PHY 351.

In one embodiment, the higher layer in the present application refers to a layer above the physical layer.

In one embodiment, the higher layer in the present application comprises the MAC layer.

In one embodiment, the higher layer in the present application comprises the RRC layer.

### Embodiment 4

Embodiment 4 illustrates a schematic diagram of a first communication device and a second communication device according to one embodiment of the present application, as shown in FIG. 4. FIG. 4 is a block diagram of a first communication device 410 in communication with a second communication device 450 in an access network.

The first communication device 410 includes a controller/processor 475, a memory 476, a receiving processor 470, a transmitting processor 416, a multi-antenna receiving processor 472, a multi-antenna transmitting processor 471, a transmitter/receiver 418, and an antenna 420.

The second communication device 450 includes a controller/processor 459, a memory 460, a data source 467, a transmitting processor 468, a receiving processor 456, a multi-antenna transmitting processor 457, a multi-antenna receiving processor 458, a transmitter/receiver 454, and an antenna 452.

In a transmission from the first communication device 410 to the second communication device 450, at the first communication device 410, a higher-layer packet from the core network is provided to the controller/processor 475. The controller/processor 475 implements L2 functionality. In DL transmission, the controller/processor 475 provides header compression, encryption, packet segmentation and reordering, and multiplexing between a logical channel and a transport channel, and radio resource allocation for the second communication device 450 based on various priorities. The controller/processor 475 is also in charge of HARQ operation, retransmission of a lost packet, and a signaling to the second communication node 450. The transmitting processor 416 and the multi-antenna transmitting processor 471 perform various signal processing functions used for the LI layer (that is, PHY). The transmitting processor 416 implements encoding and interleaving to facilitate Forward Error Correction (FEC) at the second communication device 450, as well as mapping of signal clusters based on various modulation schemes such as Binary Phase Shift Keying (BPSK), Quadrature Phase Shift Keying (QPSK), M-ary Phase Shift Keying (M-PSK), and M-Quadrature Amplitude Modulation (M-QAM). The multi-antenna transmitting processor 471 performs digital spatial precoding, including codebook-based precoding and non-codebook-based precoding, and beamforming on encoded and modulated symbols to generate one or more parallel streams. The transmitting processor 416 then maps cach of the parallel streams to a subcarrier, multiplexes the modulated symbols with a reference signal (e.g., a pilot frequency) in time domain and/or frequency domain, and subsequently uses an Inverse Fast Fourier Transform (IFFT) to generate a physical channel carrying the time-domain multicarrier symbol stream. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, cach receiver 454 receives signals through its corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 implement various signal processing functions of L1. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using Fast Fourier Transform (FFT). In frequency domain, a physical-layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted parallel stream. Symbols on each parallel stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2.

The controller/processor 459 can be connected to a memory 460 that stores program code and data. The memory 460 can be called a computer readable medium. In downlink (DL) transmission, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2, or various control signals can be provided to the L3 layer for processing. The controller/processor 459 is also responsible for error detection using ACKnowledgement (ACK) and/or Negative ACKnowledgement (NACK) protocols to support HARQ operations.

In a transmission from the second communication device 450 to the first communication device 410, the data source 467 is used at the second communication device 450 to provide upper layer data packets to the controller/processor 459. The data source 467 represents all protocol layers above the L2. Similar to a transmitting function of the first communication device 410 described in DL transmission, the controller/processor 459 performs header compression, encryption, packet segmentation and reordering, and multiplexing between a logical channel and a transport channel based on radio resource allocation of the first communication device 410 so as to provide the L2 functions used for the user plane and the control plane. The controller/processor 459 is also responsible for HARQ operation, retransmission of a lost packet, and a signaling to the first communication device 410. The transmitting processor 468 performs modulation mapping and channel coding processing, the multi-antenna transmitting processor 457 performs digital multi-antenna spatial precoding, including codebook-based precoding and non-codebook-based precoding, and beamforming processing, then the transmitting processor 468 modulates the generated parallel stream into a multicarrier/single-carrier symbol stream, which undergoes an analog precoding/beamforming operation in the multi-antenna transmitting processor 457 before being provided to the different antennas 452 via the transmitter 454. Each transmitter 454 first converts the baseband symbol stream provided by the multi-antenna transmitting processor 457 into an RF symbol stream, and then provides it to the antenna 452.

In a transmission from the second communication device 450 to the first communication device 410, the function at the first communication device 410 is similar to the receiving function at the second communication device 450 described in a transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly implement the function of L1. The controller/processor 475 implements L2 function. The controller/processor 475 can be connected with the memory 476 that stores program code and data. The memory 476 can be called a computer readable medium. The controller/processor 475 provides de-multiplexing between a transport channel and a logical channel, packet reassembling, decryption, header decompression, control signal processing so as to recover a higher-layer packet from the second communication device 450. The higher-layer packet coming from the controller/processor 475 may be provided to the core network. The controller/processor 475 can also perform error detection using ACK and/or NACK protocols to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least receives a first reference signal in a first RS resource; operates a first signal firstly on a first frequency band; a duplex mode of the first frequency band is a frequency division duplex; the first operating is to receive and the first signal is on a downlink working band, or the first operating is to transmit and the first signal is on an uplink working band; the first signal is spatially associated with the first RS resource; when the first operating is to receive, time-domain resources occupied by the first signal are not overlapping with a first time-domain resource pool; when the first operating is to transmit, time-domain resources occupied by the first signal are not overlapping with a second time-domain resource pool; time-domain resources occupied by the first time-domain resource pool are orthogonal to time-domain resources occupied by the second time-domain resource pool.

In one embodiment, the second communication device 450 comprises a memory that stores a computer readable instruction program. The computer readable instruction program generates an action when executed by at least one processor. The action includes: receiving a first reference signal in a first RS resource; first operating a first signal on a first frequency band.

In one embodiment, the first communication device 410 comprises at least one processor and at least one memory. The at least one memory comprises computer program codes; the at least one memory and the computer program codes are configured to be used in collaboration with the at least one processor. The first communication device 410 at least transmits a first reference signal in a first RS resource; operates a first signal thirdly on a first frequency band; a duplex mode of the first frequency band is a frequency division duplex; the third operating is to transmit and the first signal is on a downlink working band, or the third operating is to receive and the first signal is on an uplink working band; the first signal is spatially associated with the first RS resource; when the third operating is to transmit, time-domain resources occupied by the first signal are not overlapping with a first time-domain resource pool; when the third operating is to receive, time-domain resources occupied by the first signal are not overlapping with a second time-domain resource pool; time-domain resources occupied by the first time-domain resource pool are orthogonal to time-domain resources occupied by the second time-domain resource pool.

In one embodiment, the first communication device 410 comprises a memory that stores a computer readable instruction program. The computer readable instruction program generates an action when executed by at least one processor. The action includes: transmitting a first reference signal in a first RS resource; third operating a first signal on a first frequency band.

In one embodiment, the first node comprises the second communication device 450 in the present application.

In one embodiment, the second node in the present application comprises the first communication device 410.

In one embodiment, at least one of the antenna 420, the transmitter 418, the transmitting processor 416, the multi-antenna transmitting processor 471, the controller/processor 475, or the memory 476 is used to transmit a first reference signal in a first RS resource; at least one of the antenna 452, the receiver 454, the receiving processor 456, the multi-antenna receiving processor 458, the controller/processor 459, the memory 460, or the data source 467 is used to receive a first reference signal in a first RS resource.

In one embodiment, at least one of the antenna 420, the receiver 418, the receiving processor 470, the multi-antenna receiving processor 472, the controller/processor 475, or the memory 476 is used to receive a first signal on a first frequency band; at least one of the antenna 452, the transmitter 454, the transmitting processor 468, the multi-antenna transmitting processor 457, the controller/processor 459, the memory 460, or the data source 467 is used to transmit a first signal on a first frequency band.

In one embodiment, at least one of the antenna 420, the transmitter 418, the transmitting processor 416, the multi-antenna transmitting processor 471, the controller/processor 475, or the memory 476 is used to transmit a first signal on a first frequency band; at least one of the antenna 452, the receiver 454, the receiving processor 456, the multi-antenna receiving processor 458, the controller/processor 459, the memory 460, or the data source 467 is used to receive a first signal on a first frequency band.

In one embodiment, at least one of the antenna 420, the transmitter 418, the transmitting processor 416, the multi-antenna transmitting processor 471, the controller/processor 475, or the memory 476 is used to transmit a first signaling; at least one of the antenna 452, the receiver 454, the receiving processor 456, the multi-antenna receiving processor 458, the controller/processor 459, the memory 460, or the data source 467 is used to receive a first signaling.

In one embodiment, at least one of the antenna 420, the transmitter 418, the transmitting processor 416, the multi-antenna transmitting processor 471, the controller/processor 475, or the memory 476 is used to transmit a second signaling; at least one of the antenna 452, the receiver 454, the receiving processor 456, the multi-antenna receiving processor 458, the controller/processor 459, the memory 460, or the data source 467 is used to receive a second signaling.

In one embodiment, at least one of the antenna 420, the transmitter 418, the transmitting processor 416, the multi-antenna transmitting processor 471, the controller/processor 475, or the memory 476 is used to transmit a third signaling; at least one of the antenna 452, the receiver 454, the receiving processor 456, the multi-antenna receiving processor 458, the controller/processor 459, the memory 460, or the data source 467 is used to transmit a third signaling.

In one embodiment, at least one of the antenna 420, the transmitter 418, the transmitting processor 416, the multi-antenna transmitting processor 471, the controller/processor 475, or the memory 476 is used to transmit a fourth signaling in the present application; at least one of the antenna 452, the receiver 454, the receiving processor 456, the multi-antenna receiving processor 458, the controller/processor 459, the memory 460, or the data source 467 is used to transmit a fourth signaling.

In one embodiment, at least one of the antenna 420, the transmitter 418, the transmitting processor 416, the multi-antenna transmitting processor 471, the controller/processor 475, or the memory 476 is used to transmit a second reference signal in a second RS resource; at least one of the antenna 452, the receiver 454, the receiving processor 456, the multi-antenna receiving processor 458, the controller/processor 459, the memory 460, or the data source 467 is used to receive a second reference signal in a second RS resource.

In one embodiment, at least one of the antenna 420, the receiver 418, the receiving processor 470, the multi-antenna receiving processor 472, the controller/processor 475, or the memory 476 is used to receive a second signal on a first frequency band; at least one of the antenna 452, the transmitter 454, the transmitting processor 468, the multi-antenna transmitting processor 457, the controller/processor 459, the memory 460, or the data source 467 is used to transmit a second signal on a first frequency band.

In one embodiment, at least one of the antenna 420, the transmitter 418, the transmitting processor 416, the multi-antenna transmitting processor 471, the controller/processor 475, or the memory 476 is used to transmit a second signal on a first frequency band; at least one of the antenna 452, the receiver 454, the receiving processor 456, the multi-antenna receiving processor 458, the controller/processor 459, the memory 460, or the data source 467 is used to receive a second signal on a first frequency band.

### Embodiment 5

Embodiment 5 illustrates a first flowchart of transmission between a first node and a second node according to one embodiment of the present application. In FIG. 5, the first node U1 is in communications with the second node N2 via a radio link, and the steps in box 51 and box F52 are optional. It is particularly underlined that the order illustrated in the embodiment does not put constraints over sequences of signal transmissions and implementations.

The first node U1 receives a first reference signal in the first RS resource in Step S510; transmits a first signal on a first frequency band in step S5110 or receives a first signal on a first frequency band in step S5120.

The second node N2 transmits a first reference signal in a first RS resource in step S520; receives a first signal on a first frequency band in step S5210 or transmits a first signal on a first frequency band in step S5220.

In embodiment 5, a duplex mode of the first frequency band is a frequency division duplex; the first node U1 receives the first signal on a first frequency band and the first signal is on a downlink working band, or the first node U1 transmits the first signal on a first frequency band and the first signal is on an uplink working band; the first signal is spatially associated with the first RS resource; when the first node U1 receives the first signal on a first frequency band, time-domain resources occupied by the first signal are not overlapping with a first time-domain resource pool; when the first node U1 transmits the first signal on a first frequency band, time-domain resources occupied by the first signal are not overlapping with a second time-domain resource pool; time-domain resources occupied by the first time-domain resource pool are orthogonal to time-domain resources occupied by the second time-domain resource pool.

In one embodiment, the first node U1 is the first node in the present application.

In one embodiment, the second node N2 is the second node in the present application.

In one embodiment, an air interface between the second node N2 and the first node U1 comprises a radio interface between a base station and a UE.

In one embodiment, an air interface between the second node N2 and the first node U1 comprises a

radio interface between a relay node and a UE.

In one embodiment, an air interface between the second node N2 and the first node U1 comprises a radio interface between a UE and a UE.

In one embodiment, the second node N2 is a maintenance base station of a serving cell of the first node U1.

In one embodiment, steps in box F51 in FIG. 5 exist and steps in box F52 in FIG. 5 do not exist; a method to be applied to the first node U1 in the present application includes: transmitting a first signal on a first frequency band.

In one subembodiment of the embodiment, the first signal is transmitted on an uplink physical control channel (i.e, an uplink channel capable of bearing a physical-layer signaling).

In one subembodiment of the embodiment, a physical-layer channel occupied by the first signal comprises a Physical Uplink Control Channel (PUCCH).

In one subembodiment of the embodiment, the first signal is transmitted on an uplink physical data channel (i.e., an uplink channel capable of bearing physical-layer data).

In one subembodiment of the embodiment, a physical-layer channel occupied by the first signal comprises a Physical Uplink Shared CHannel (PUSCH).

In one subembodiment of the embodiment, a physical-layer channel occupied by the first signal comprises a Physical Random Access CHannel (PRACH).

In one subembodiment of the embodiment, a transmission channel corresponding to the first signal comprises a UL-SCH (UpLink Shared CHannel).

In one subembodiment of the embodiment, a transmission channel corresponding to the first signal comprises an RACH (Random Access CHannel).

In one subembodiment of the above embodiment, the step S510 is taken before the step S5110; the step S520 is taken before the step S5210.

In one embodiment, steps in box F52 in FIG. 5 exist and steps in box F51 in FIG. 5 do not exist; a method to be applied to the first node U1 in the present application includes: receiving a first signal on a first frequency band.

In one subembodiment of the embodiment, the first signal is transmitted on a downlink physical control channel (i.e, a downlink channel only capable of bearing a physical-layer signaling).

In one subembodiment of the embodiment, a physical-layer channel occupied by the first signal comprises a Physical Downlink Control CHannel (PDCCH).

In one subembodiment of the embodiment, the first signal is transmitted on a downlink physical data channel (i.e., a downlink channel capable of bearing physical-layer data).

In one subembodiment of the embodiment, a physical-layer channel occupied by the first signal comprises a Physical Downlink Shared CHannel (PDSCH).

In one subembodiment of the embodiment, a transmission channel corresponding to the first signal comprises a DL-SCH (DownLink-Shared CHannel).

In one subembodiment of the above embodiment, the step S510 is taken before the step S5120; the step S520 is taken before the step S5220.

### Embodiment 6

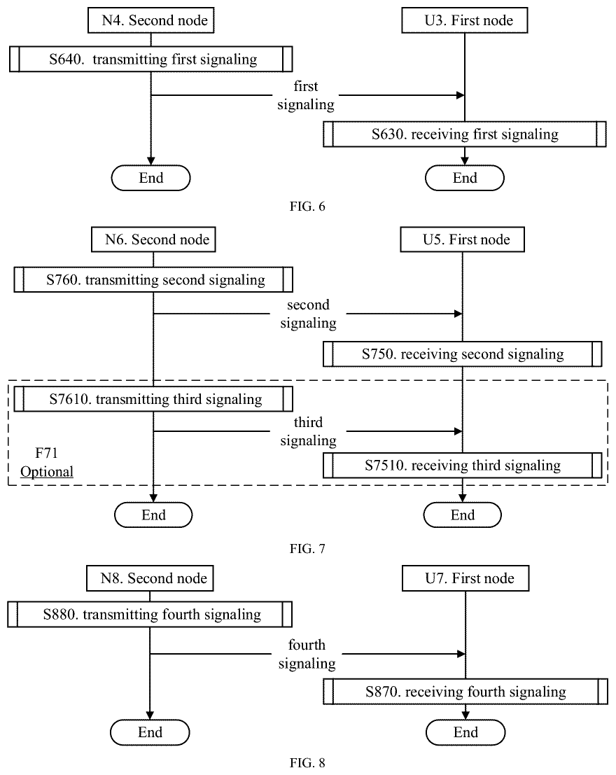

Embodiment 6 illustrates a second flowchart of transmission between a first node and a second node according to one embodiment of the present application. In FIG. 6, a first node U3 and a second node N4 are in communications via a radio link. It is particularly underlined that the order illustrated in the embodiment does not put constraints over sequences of signal transmissions and implementations.

The first node U3 receives a first signaling in step S630.

The second node N4 transmits a first signaling in step S640.

In Embodiment 6, the first signaling indicates a first RS resource set; only when the first RS resource is an RS resource in the first RS resource set, the first time-domain resource pool and the second time-domain resource pool are applied.

In one embodiment, the first node U3 is the first node in the present application.

In one embodiment, the second node N4 is the second node in the present application.

In one embodiment, an air interface between the second node N4 and the first node U3 comprises a radio interface between a base station and a UE.

In one embodiment, an air interface between the second node N4 and the first node U3 comprises a radio interface between a relay node and a UE.

In one embodiment, an air interface between the second node N4 and the first node U3 comprises a radio interface between a UE and a UE.

In one embodiment, the second node N4 is a maintenance base station of a serving cell of the first node U3.

In one embodiment, the first signaling comprises a higher-layer signaling.

In one embodiment, the first signaling comprises a Radio Resource Control (RRC) signaling.

In one embodiment, the first signaling comprises one or multiple RRC IEs (Information Elements).

In one embodiment, the first signaling comprises one or multiple fields in at least one RRC IE.

In one embodiment, the first signaling comprises information in all or partial fields in each RRC IE in multiple RRC IEs.

In one embodiment, the first signaling comprises one or multiple fields in a ServingCellConfigCommonSIB IE.

In one embodiment, the first signaling comprises one or multiple fields in ServingCellConfigCommon IE.

In one embodiment, the first signaling comprises one or multiple fields in CellGroupConfig IE.

In one embodiment, the first signaling comprises one or multiple fields in ServingCellConfig IE.

In one embodiment, the first signaling comprises at least one CSI-MeasConfig IE.

In one embodiment, the first signaling comprises at least one CSI-IM-ResourceSet IE.

In one embodiment, the first signaling comprises at least one CSI-IM-Resource IE.

In one embodiment, the first signaling comprises at least one NZP-CSI-RS-ResourceSet IE.

In one embodiment, the first signaling comprises at least one NZP-CSI-RS-Resource IE.

In one embodiment, the first signaling comprises one or multiple fields in CSI-SSB-ResourceSet IE.

In one embodiment, the first signaling comprises one or multiple fields in CSI-ResourceConfig IE.

In one embodiment, the first signaling comprises at least one CSI-ReportConfig IE.

In one embodiment, the first signaling comprises ssb-PositionsInBurst in ServingCellConfigCommonSIB IE.

In one embodiment, the first signaling comprises ssb-PositionsInBurst in ServingCellConfigCommon IE.

In one embodiment, the first signaling comprises a MAC (Medium Access Control) signaling.

In one embodiment, the first signaling comprises a MAC CE (Control Element).

In one embodiment, the first signaling indicates RS resources comprised in the first RS resource set.

In one embodiment, the first signaling indicates a number of RS resources comprised in the first RS resource set.

In one embodiment, the first signaling indicates an RS resource identity of RS resources comprised in the first RS resource set.

In one embodiment, the first signaling indicates an RS resource set identity corresponding to the first RS resource set.

In one embodiment, the first signaling indicates a type of RS resources comprised in the first RS resource set.

In one subembodiment of the embodiment, a type of the RS resources comprises one of periodic, semi-persistent and aperiodic.

In one embodiment, the first signaling indicates configuration information of the first RS resource set.

In one embodiment, the first RS resource set comprises K1 RS resource(s), K1 being a positive integer.

In one subembodiment of the above embodiment, K1 is equal to 1.

In one subembodiment of the above embodiment, K1 is a positive integer greater than 1.

In one subembodiment of the above embodiment, the first signaling implicitly indicates the K1.

In one subembodiment of the above embodiment, the K1 RS resource(s) comprises (comprise) the first RS resource.

In one subembodiment of the above embodiment, the K1 RS resource(s) comprises (comprise) at least one CSI-RS resource or at least one SSB.

In one subembodiment of the above embodiment, the K1 RS resource(s) comprises (comprise) at least one CSI-RS resource.

In one subembodiment of the above embodiment, the K1 RS resource(s) comprises (comprise) at least one NZP CSI-RS resource.

In one subembodiment of the above embodiment, at least one RS resource in the K1 RS resource(s) occupies one CSI-RS resource set.

In one subsidiary embodiment of the subembodiment, the CSI-RS resource set is the first RS resource set.

In one subembodiment of the above embodiment, at least one RS resource in the K1 RS resource(s) occupies one NZP CSI-RS resource set.

In one subsidiary embodiment of the subembodiment, the NZP CSI-RS resource set is the first RS resource set.

In one subembodiment of the above embodiment, the K1 RS resource(s) comprises (comprise) at least one SSB.

In one subembodiment of the above embodiment, the K1 RS resource(s) is (are) associated with at least one RS resource identity.

In one subembodiment of the above embodiment, the K1 RS resource(s) is (are) associated with at least one NZP-CSI-RS-ResourceId.

In one subembodiment of the above embodiment, the K1 RS resource(s) is (are) associated with at least one SSB-Index.

In one subembodiment of the above embodiment, the K1 RS resource(s) is (are) associated with at least one ssb-Index.

In one subembodiment of the above embodiment, at least one RS resource in the K1 RS resource(s) corresponds to an RS resource set identity.

In one subsidiary embodiment of the subembodiment, the first RS resource set is identified by the RS resource set identity.

In one subembodiment of the above embodiment, at least one RS resource in the K1 RS resource(s) corresponds to NZP-CSI-RS-ResourceSetId.

In one subsidiary embodiment of the subembodiment, the first RS resource set is identified by the NZP-CSI-RS-ResourceSetId.

In one subembodiment of the above embodiment, the K1 RS resource is (are respectively) K1 CSI-RS resource(s) or K1 SSB(s).

In one subembodiment of the above embodiment, the K1 RS resource(s) is (are respectively) K1 CSI-RS resource(s).

In one subembodiment of the above embodiment, the K1 RS resource(s) is (are respectively) K1 NZP CSI-RS resource(s).

In one subembodiment of the above embodiment, the K1 RS resource(s) belongs (belong) to a CSI-RS resource set.

In one subsidiary embodiment of the subembodiment, the CSI-RS resource set is the first RS resource set.

In one subembodiment of the above embodiment, the K1 RS resource(s) belongs (belong) an NZP CSI-RS resource set.

In one subsidiary embodiment of the subembodiment, the NZP CSI-RS resource set is the first RS resource set.

In one subembodiment of the above embodiment, the K1 RS resource(s) is (are respectively) K1 SSB(s).

In one subembodiment of the above embodiment, the K1 RS resource(s) belongs (belong) to an SSB burst.

In one subsidiary embodiment of the subembodiment, the SSB burst is the first RS resource set.

In one subembodiment of the above embodiment, the K1 RS resource(s) associates (respectively associate) with K1 RS resource identity (identities).

In one subembodiment of the above embodiment, the K1 RS resource(s) is (are respectively) associated with K1 NZP-CSI-RS-ResourceId(s).

In one subembodiment of the above embodiment, the K1 RS resource(s) corresponds (respectively correspond) to K1 SSB-Index(es).

In one subembodiment of the above embodiment, the K1 RS resource(s) corresponds (respectively

correspond) to K1 ssb-Index(es).

In one subembodiment of the above embodiment, the K1 RS resource(s) corresponds (correspond) to an NZP CSI-RS resource set identity.

In one subsidiary embodiment of the subembodiment, the first RS resource set is identified by the RS resource set identity.

In one subembodiment of the above embodiment, the K1 RS resource(s) corresponds (correspond) to an NZP-CSI-RS-ResourceSetId.

In one subsidiary embodiment of the subembodiment, the first RS resource set is identified by the NZP-CSI-RS-ResourceSetId.

In one embodiment, the meaning that the characteristic that only when the first RS resource is an RS resource in the first RS resource set, the first time-domain resource pool and the second time-domain resource pool are applied comprises: only when the first RS resource is an RS resource in the first RS resource set and the first operating is to receive, time-domain resources occupied by the first signal are limited outside the first time-domain resource pool.

In one embodiment, the meaning that the characteristic that only when the first RS resource is an RS resource in the first RS resource set, the first time-domain resource pool and the second time-domain resource pool are applied comprises: only when the first RS resource is an RS resource in the first RS resource set and the first operating is to transmit, time-domain resources occupied by the first signal are limited outside the second time-domain resource pool.

In one embodiment, the meaning that the characteristic that only when the first RS resource is an RS resource in the first RS resource set, the first time-domain resource pool and the second time-domain resource pool are applied comprises: when the first RS resource is an RS resource outside the first RS resource set, time-domain resources occupied by the first signal are not limited by the first time-domain resource pool.

In one embodiment, the meaning that the characteristic that only when the first RS resource is an RS resource in the first RS resource set, the first time-domain resource pool and the second time-domain resource pool are applied comprises: when the first RS resource is an RS resource outside the first RS resource set, time-domain resources occupied by the first signal are not limited by the second time-domain resource pool.

In one embodiment, the meaning that the characteristic that only when the first RS resource is an RS resource in the first RS resource set, the first time-domain resource pool and the second time-domain resource pool are applied comprises: when the first RS resource is an RS resource outside the first RS resource set, time-domain resources occupied by the first signal are independent of a configuration of the first time-domain resource pool.

In one embodiment, the meaning that the characteristic that only when the first RS resource is an RS resource in the first RS resource set, the first time-domain resource pool and the second time-domain resource pool are applied comprises: when the first RS resource is an RS resource outside the first RS resource set, time-domain resources occupied by the first signal are independent of a configuration of the second time-domain resource pool.

In one embodiment, the first time-domain resource pool and the second time-domain resource pool are configured only when the first RS resource is an RS resource in the first RS resource set.

In one embodiment, the first time-domain resource pool is a configuration for the first RS resource.

In one embodiment, the second time-domain resource pool is a configuration for the first RS resource.

In one embodiment, the first time-domain resource pool is a configuration for the first RS resource set.

In one embodiment, the second time-domain resource pool is a configuration for the first RS resource set.

In one embodiment, the first signaling implicitly indicates whether the first time-domain resource pool and the second time-domain resource pool are applied.

In one embodiment, the first time-domain resource pool and the second time-domain resource pool are configured only when the first RS resource set is configured.

In one embodiment, at least one of the first time-domain resource pool or the second time-domain resource pool is associated with the first RS resource set.

In one embodiment, at least one of the first time-domain resource pool or the second time-domain resource pool is applied into the first RS resource set.

In one embodiment, the first signaling is transmitted on a downlink physical data channel (i.e., a downlink channel capable of bearing physical-layer data).

In one embodiment, a physical-layer channel occupied by the first signaling comprises a PDSCH.

In one embodiment, a transmission channel corresponding to the first signaling comprises a DL-SCH.

In one embodiment, the step S630 exists, and the step S630 is taken before the step S510 in Embodiment 5 in the present application.

In one embodiment, the step S640 exists, and the step S640 is taken before the step S520 in Embodiment 5 in the present application.

### Embodiment 7

Embodiment 7 illustrates a third flowchart of transmission between a first node and a second node according to one embodiment of the present application. In FIG. 7, the first node U5 is in communications with the second node N6 via a radio link, and steps in box 71 in the embodiment are optional. It is particularly underlined that the order illustrated in the embodiment does not put constraints over sequences of signal transmissions and implementations.

The first node U5 receives a second signaling in step S750; receives a third signaling in step S7510.

The second node N6 transmits a second signaling in step S760; transmits a third signaling in step S7610.

In embodiment 7, the second signaling is used to configure the first time-domain resource set and the second time-domain resource set; the third signaling is used to configure the first time-domain resource set and the second time-domain resource set; the second signaling is a higher-layer signaling, and the third signaling is a physical-layer signaling.

In one embodiment, the first node U5 is the first node in the present application.

In one embodiment, the second node N6 is the second node in the present application.

In one embodiment, an air interface between the second node N6 and the first node U5 comprises a radio interface between a base station and a UE.

In one embodiment, an air interface between the second node N6 and the first node U5 comprises a radio interface between a relay node and a UE.

In one embodiment, an air interface between the second node N6 and the first node U5 comprises a radio interface between a UE and a UE.

In one embodiment, the second node N6 is a maintenance base station of a serving cell of the first node U5.

In one embodiment, the second signaling is used to configure the first time-domain resource set and the second time-domain resource set.

In one embodiment, the second signaling is a higher-layer signaling.

In one embodiment, the second signaling is broadcast.

In one embodiment, the second signaling is cell-common.

In one embodiment, the second signaling is cell-specific.

In one embodiment, the second signaling is group-common.

In one embodiment, the second signaling is UE-dedicated.

In one embodiment, the second signaling comprises an RRC signaling.

In one embodiment, the second signaling comprises one or multiple RRC IEs.

In one embodiment, the second signaling comprises one or multiple fields in at least one RRC IE.

In one embodiment, the second signaling comprises information in all or partial fields in each RRC IE in multiple RRC IEs.

In one embodiment, the second signaling comprises a tdd-UL-DL-ConfigurationCommon field.

In one embodiment, the second signaling comprises TDD-UL-DL-ConfigCommon IE.

In one embodiment, the second signaling configures a period of the first time-domain resource set in time domain.

In one embodiment, the second signaling configures a subframe occupied by the first time-domain resource set.

In one embodiment, the second signaling configures a slot occupied by the first time-domain resource set.

In one embodiment, the second signaling configures a slot comprised in the first time-domain resource set.

In one embodiment, the second signaling configures a time-domain location of a slot comprised in the first time-domain resource set.

In one embodiment, the second signaling configures a location of a slot comprised in the first time-domain resource set in a period.

In one embodiment, the second signaling configures a multicarrier symbol occupied by the first time-domain resource set.

In one embodiment, the second signaling configures a time-domain location of a multicarrier symbol occupied by the first time-domain resource set.

In one embodiment, the second signaling configures a location of a multicarrier symbol occupied by the first time-domain resource set in a slot.

In one embodiment, the second signaling configures a location of a multicarrier symbol occupied by the first time-domain resource set in a period.

In one embodiment, the second signaling configures a location of a slot occupied by a multicarrier symbol occupied by the first time-domain resource set.

In one embodiment, the second signaling configures a location of a slot occupied by a multicarrier symbol occupied by the first time-domain resource set in a period.

In one embodiment, the second signaling configures a period of the second time-domain resource set in time domain.

In one embodiment, the second signaling configures a subframe occupied by the second time-domain resource set.

In one embodiment, the second signaling configures a slot occupied by the second time-domain resource set.

In one embodiment, the second signaling configures a slot comprised in the second time-domain resource set.

In one embodiment, the second signaling configures a time-domain location of a slot comprised in the second time-domain resource set.

In one embodiment, the second signaling configures a location of a slot comprised in the second time-domain resource set in a period.

In one embodiment, the second signaling configures a multicarrier symbol occupied by the second time-domain resource set.

In one embodiment, the second signaling configures a time-domain location of a multicarrier symbol occupied by the second time-domain resource set.

In one embodiment, the second signaling configures a location of a multicarrier symbol occupied by the second time-domain resource set in a slot.

In one embodiment, the second signaling configures a location of a multicarrier symbol occupied by the second time-domain resource set in a period.

In one embodiment, the second signaling configures a location of a slot occupied by a multicarrier symbol occupied by the second time-domain resource set.

In one embodiment, the second signaling configures a location of a slot occupied by a multicarrier symbol occupied by the second time-domain resource set in a period.

In one embodiment, the second signaling is transmitted on a downlink physical data channel (i.e., a downlink channel capable of bearing physical-layer data).

In one embodiment, a physical-layer channel occupied by the second signaling comprises a PDSCH.

In one embodiment, a transmission channel corresponding to the second signaling comprises a DL-SCH.

In one embodiment, the first signaling and the second signaling in the present application belong to a ServingCellConfigCommon IE.

In one embodiment, the first signaling and the second signaling in the present application are respectively two different fields in a ServingCellConfigCommon IE.

In one embodiment, the step S750 exists, and the step S750 is taken before the step S510 in Embodiment 5 in the present application.

In one embodiment, the step S760 exists, and the step S760 is taken before the step S520 in Embodiment 5 in the present application.

In one embodiment, the step S750 exists, and the step S750 is taken before the step S630 in Embodiment 6 in the present application.

In one embodiment, the step S760 exists, and the step S760 is taken before the step S640 in Embodiment 6 in the present application.

In one embodiment, the step S750 exists, and the step S750 is taken after the step S630 in Embodiment 6 in the present application.

In one embodiment, the step S760 exists, and the step S760 is taken after the step S640 in Embodiment 6 in the present application.

In one embodiment, the step S750 exists, and the step S750 and the step S630 in Embodiment 6 of the present application occur at the same time.

In one embodiment, the step S760 exists, and the step S760 and the step S640 in Embodiment 6 of the present application occur at the same time.

In one embodiment, steps in box F71 in FIG. 7 exist; a method to be applied to the first node U5 in the present application comprises: receiving a third signaling.

In one subembodiment of the embodiment, the third signaling is used to configure the first time-domain resource set and the second time-domain resource set, and the third signaling is a physical-layer signaling.

In one embodiment, the third signaling is used to indicate the first time-domain resource set and the second time-domain resource set.

In one embodiment, the third signaling is a physical-layer signaling.

In one embodiment, the third signaling comprises Downlink Control Information (DCI).

In one embodiment, the third signaling comprises partial or all fields in a DCI format.

In one embodiment, the third signaling is DCI.

In one embodiment, the third signaling is DCI, and a DCI format of the DCI is DCI format 2_0.

In one embodiment, the third signaling comprises an SFI (Slot Format Indication).

In one embodiment, the third signaling is an SFI.

In one embodiment, the third signaling is a scheduling signaling.

In one embodiment, the first operating is to receive, and the third signaling is a downlink scheduling signaling.

In one embodiment, the first operating is to receive, and the third signaling comprises downlink assignment.

In one embodiment, the first operating is to transmit, and the third signaling is an uplink scheduling signaling.

In one embodiment, the first operating is to transmit, and the third signaling comprises an uplink grant.

In one embodiment, the third signaling is used to configure the first time-domain resource set from the first time-domain resource pool.

In one embodiment, the third signaling is used to configure the second time-domain resource set from the second time-domain resource pool.

In one embodiment, the third signaling is used to indicate the first time-domain resource set from the first time-domain resource pool.

In one embodiment, the third signaling is used to indicate the second time-domain resource set from the second time-domain resource pool.

In one embodiment, the third signaling is transmitted on a downlink physical control channel (i.e., a downlink channel only capable of bearing a physical-layer signaling).

In one embodiment, a physical-layer channel occupied by the third signaling comprises a PDCCH.

In one embodiment, steps in box 71 in FIG. 7 exist and the step S7510 is taken after the step S750.

In one embodiment, steps in box 71 in FIG. 7 exist and the step S7610 is taken after the step S760.

In one embodiment, steps in box 71 in FIG. 7 exist, and the step S7510 is taken before the step S510 in Embodiment 5 in the present application.

In one embodiment, steps in box 71 in FIG. 7 exist, and the step S7610 is taken before the step S520 in Embodiment 5 in the present application.

In one embodiment, steps in box 71 in FIG. 7 exist, and the step S7510 is taken after the step S630 in Embodiment 6 in the present application.

In one embodiment, steps in box 71 in FIG. 7 exist, and the step S7610 is taken after the step S640 in Embodiment 6 in the present application.

### Embodiment 8

Embodiment 8 illustrates a fourth flowchart of transmission between a first node and a second node according to one embodiment of the present application. In FIG. 8, a first node U7 and a second node N8 are in communications via a radio link. It is particularly underlined that the order illustrated in the embodiment does not put constraints over sequences of signal transmissions and implementations.

The first node U7 receives a fourth signaling in step S870.

The second node N8 transmits a fourth signaling in step S880.

In embodiment 8, the fourth signaling is used to configure the first time-domain resource pool and the second time-domain resource pool.

In one embodiment, the first node U7 is the first node in the present application.

In one embodiment, the second node N8 is the second node in the present application.

In one embodiment, an air interface between the second node N8 and the first node U7 comprises a radio interface between a base station and a UE.

In one embodiment, an air interface between the second node N8 and the first node U7 comprises a radio interface between a relay node and a UE.

In one embodiment, an air interface between the second node N8 and the first node U7 comprises a radio interface between a UE and a UE.

In one embodiment, the second node N8 is a maintenance base station of a serving cell of the first node U7.

In one embodiment, the fourth signaling is a higher-layer signaling.

In one embodiment, the fourth signaling is a broadcast signaling.

In one embodiment, the second signaling is cell-common.

In one embodiment, the second signaling is cell-specific.

In one embodiment, the second signaling is group-common.

In one embodiment, the second signaling comprises an RRC signaling.

In one embodiment, the second signaling comprises one or multiple RRC IEs.

In one embodiment, the second signaling comprises one or multiple fields of at least one RRC IE.

In one embodiment, the second signaling comprises information in all or partial fields in each RRC IE in multiple RRC IEs.

In one embodiment, a name of an RRC signaling used to bear the fourth signaling includes ‘UL’.

In one embodiment, a name of an RRC signaling used to bear the fourth signaling includes ‘DL’.

In one embodiment, a name of an RRC signaling used to bear the fourth signaling includes ‘TDD’.

In one embodiment, a name of an RRC signaling used to bear the fourth signaling includes ‘Config’.

In one embodiment, a name of an RRC signaling used to bear the fourth signaling includes ‘Configuration’.

In one embodiment, a name of an RRC signaling used to bear the fourth signaling includes ‘Common’.

In one embodiment, a name of an RRC signaling used to bear the fourth signaling includes ‘RIS’.

In one embodiment, a name of an RRC signaling used to bear the fourth signaling includes ‘IRS’.

In one embodiment, the fourth signaling configures a period of the first time-domain resource pool in time domain.

In one embodiment, the fourth signaling configures a subframe occupied by the first time-domain resource pool.

In one embodiment, the fourth signaling configures a slot occupied by the first time-domain resource pool.

In one embodiment, the fourth signaling configures a slot comprised in the first time-domain resource pool.

In one embodiment, the fourth signaling configures a time-domain location of a slot comprised in the first time-domain resource pool.

In one embodiment, the fourth signaling configures a location of a slot comprised in the first time-domain resource pool in a period.

In one embodiment, the fourth signaling configures a multicarrier symbol occupied by the first time-domain resource pool.

In one embodiment, the fourth signaling configures a time-domain location of a multicarrier symbol occupied by the first time-domain resource pool.

In one embodiment, the fourth signaling configures a location of a multicarrier symbol occupied by the first time-domain resource pool in a slot.

In one embodiment, the fourth signaling configures a location of a multicarrier symbol occupied by the first time-domain resource pool in a period.

In one embodiment, the fourth signaling configures a location of a slot occupied by a multicarrier symbol occupied by the first time-domain resource pool.

In one embodiment, the fourth signaling configures a location of a slot occupied by a multicarrier symbol occupied by the first time-domain resource pool in a period.

In one embodiment, the fourth signaling configures a period of the second time-domain resource pool in time domain.

In one embodiment, the fourth signaling configures a subframe occupied by the second time-domain resource pool.

In one embodiment, the fourth signaling configures a slot occupied by the second time-domain resource pool.

In one embodiment, the fourth signaling configures a slot comprised in the second time-domain resource pool.

In one embodiment, the fourth signaling configures a time-domain location of a slot comprised in the second time-domain resource pool.

In one embodiment, the fourth signaling configures a location of a slot comprised in the second time-domain resource pool in a period.

In one embodiment, the fourth signaling configures a multicarrier symbol occupied by the second time-domain resource pool.

In one embodiment, the fourth signaling configures a time-domain location of a multicarrier symbol occupied by the second time-domain resource pool.

In one embodiment, the fourth signaling configures a location of a multicarrier symbol occupied by the second time-domain resource pool in a slot.

In one embodiment, the fourth signaling configures a location of a multicarrier symbol occupied by the second time-domain resource pool in a period.

In one embodiment, the fourth signaling configures a location of a slot occupied by a multicarrier symbol occupied by the second time-domain resource pool.

In one embodiment, the fourth signaling configures a location of a slot occupied by a multicarrier symbol occupied by the second time-domain resource pool in a period.

In one embodiment, the first signaling, the second signaling and the fourth signaling in the present application belong to a ServingCellConfigCommon IE.

In one embodiment, the second signaling and the fourth signaling in the present application belong to a same RRC IE.

In one embodiment, the second signaling and the fourth signaling in the present application belong to a ServingCellConfigCommon IE.

In one embodiment, the first signaling, the second signaling and the fourth signaling in the present application are respectively three different fields in a ServingCellConfigCommon IE.

In one embodiment, the fourth signaling is transmitted on a downlink physical data channel (i.e., a downlink channel capable of bearing physical-layer data).

In one embodiment, a physical-layer channel occupied by the fourth signaling comprises a PDSCH.

In one embodiment, a transmission channel corresponding to the fourth signaling comprises a DL-SCH.

In one embodiment, the step S870 exists, and the step S870 is taken before the step S510 in Embodiment 5 in the present application.

In one embodiment, the step S880 exists, and the step S880 is taken before the step S520 in Embodiment 5 in the present application.

In one embodiment, the step S870 exists, and the step S870 is taken before the step S630 in Embodiment 6 in the present application.

In one embodiment, the step S880 exists, and the step S880 is taken before the step S640 in Embodiment 6 in the present application.

In one embodiment, the step S870 exists, and the step S870 is taken after the step S630 in Embodiment 6 in the present application.

In one embodiment, the step S880 exists, and the step S880 is taken after the step S640 in Embodiment 6 in the present application.

In one embodiment, the step S870 exists, and the step S870 and the step S630 in Embodiment 6 of the present application occur at the same time.

In one embodiment, the step S880 exists, and the step S880 and the step S640 in Embodiment 6 of the present application occur at the same time.

In one embodiment, the step S870 exists, and the step S870 is taken before the step S750 in Embodiment 7 in the present application.

In one embodiment, the step S880 exists, and the step S880 is taken before the step S760 in Embodiment 7 in the present application.

In one embodiment, the step S870 exists, and the step S870 is taken after the step S750 in Embodiment 7 in the present application.

In one embodiment, the step S880 exists, and the step S880 is taken after the step S760 in Embodiment 7 in the present application.

In one embodiment, the step S870 exists, and the step S870 and the step S750 in Embodiment 7 of the present application occur at the same time.

In one embodiment, the step S880 exists, and the step S880 and the step S760 in Embodiment 7 of the present application occur at the same time.

In one embodiment, the step S870 exists, and the step S870 is taken before the step S7510 in Embodiment 7 in the present application.

In one embodiment, the step S880 exists, and the step S880 is taken before the step S7610 in Embodiment 7 in the present application.

### Embodiment 9

Embodiment 9 illustrates a fifth flowchart of transmission between a first node and a second node, as shown in FIG. 9. In FIG. 9, the first node U9 and the second node N10 are in communications via a radio link, and steps in boxes 91 and F92 are optional. It is particularly underlined that the order illustrated in the embodiment does not put constraints over sequences of signal transmissions and implementations.

The first node U9 receives a second reference signal in a second RS resource in step S990; transmits a second signal on a first frequency band in step S9910 or receives a second signal on a first frequency band in step S9920.

The second node N10 transmits a second reference signal in a second RS resource in step S9100; receives a second signal on a first frequency band in step S91010 or transmits a second signal on a first frequency band in step S91020.

In embodiment 9, the first node U9 receives the second signal and the second signal is on a downlink working band, or the second node U9 transmits the second signal and the second signal is on an uplink working band; the second signal is spatially associated with the second RS resource; the first time-domain resource pool and the second time-domain resource pool are not applied to the second RS resource.

In one embodiment, the first node U9 is the first node in the present application.

In one embodiment, the second node N10 is the second node in the present application.

In one embodiment, an air interface between the second node N10 and the first node U9 comprises a radio interface between a base station and a UE.

In one embodiment, an air interface between the second node N10 and the first node U9 comprises a radio interface between a relay node and a UE.

In one embodiment, an air interface between the second node N10 and the first node U9 comprises a radio interface between a UE and a UE.

In one embodiment, the second node N10 is a maintenance base station of a serving cell of the first node U9.

In one embodiment, the second RS resource is a CSI-RS resource or SSB.

In one embodiment, the second RS resource is a CSI-RS resource.

In one embodiment, the second RS resource is an NZP CSI-RS resource.

In one embodiment, the second RS resource corresponds to an RS resource identity.

In one embodiment, the second RS resource corresponds to an NZP-CSI-RS-ResourceId.

In one embodiment, the second RS resource corresponds to a CSI-ResourceConfigId.

In one embodiment, the second RS resource corresponds to a CSI-RS resource set.

In one embodiment, the second RS resource corresponds to an NZP CSI-RS resource set.

In one embodiment, the second RS resource corresponds to an RS resource set identity.

In one subembodiment of the embodiment, an RS resource set identity corresponding to the second RS resource is different from an RS resource set identity corresponding to the first RS resource collection in the present application.

In one embodiment, the second RS resource corresponds to NZP-CSI-RS-ResourceSetId.

In one subembodiment of the embodiment, NZP-CSI-RS-ResourceSetId corresponding to the second RS resource is different from NZP-CSI-RS-ResourceSetId corresponding to the first RS resource set in the present application.

In one embodiment, the second RS resource is an SSB.

In one embodiment, the second RS resource corresponds to an SSB-Index.

In one embodiment, the second RS resource corresponds to an ssb-Index.

In one embodiment, the second RS resource comprises one or multiple antennas.

In one subembodiment of the embodiment, the one or multiple antennas comprised in the second RS resource are respectively CSI-RS ports.

In one subembodiment of the embodiment, the one or multiple antennas comprised in the second RS resource are respectively antenna ports.

In one embodiment, the second RS resource comprises a reference signal.

In one embodiment, the second RS resource comprises a reference signal transmitted in the second RS resource.

In one embodiment, the second reference signal is a downlink reference signal.

In one embodiment, the second reference signal is a CSI-RS or an SSB.

In one embodiment, the second reference signal is a CSI-RS.

In one embodiment, the second reference signal is an SSB.

In one embodiment, the second RS resource occupies at least one symbol in time domain.

In one embodiment, the second RS resource occupies multiple continuous symbols in time domain.

In one embodiment, the second RS resource occupies a slot in time domain.

In one embodiment, the second RS resource occupies a subframe in time domain.

In one embodiment, the second RS resource occupies at least one sub-band in frequency domain.

In one embodiment, the second RS resource occupies at least one RB in frequency domain.

In one embodiment, the second RS resource occupies a group of downlink PRBs.

In one embodiment, the second RS resource occupies at least one RE.

In one embodiment, the meaning of the characteristic of receiving a second reference signal on a second RS resource comprises: receiving the second reference signal in an RE corresponding to the second RS resource.

In one embodiment, the meaning of the characteristic of receiving a second reference signal on a second RS resource comprises: receiving the second reference signal according to power control parameters of the second RS resource.

In one embodiment, the meaning of the characteristic of receiving a second reference signal on a second RS resource comprises: receiving the second reference signal according to spatial reception parameters of the second RS resource.

In one embodiment, the meaning of the characteristic of receiving a second reference signal on a second RS resource comprises: receiving the second reference signal according to configuration information of the second RS resource.

In one embodiment, the second signal comprises a baseband signal.

In one embodiment, the second signal comprises a radio-frequency signal.

In one embodiment, the second signal comprises a radio signal.

In one embodiment, the meaning of the characteristic that the second signal is spatially associated with the second RS resource comprises: the second signal and the second RS resource are QCLed.

In one embodiment, the meaning of the characteristic that the second signal is spatially associated with the second RS resource comprises: the second signal and a radio signal received in the second RS resource are QCLed.

In one embodiment, the meaning of the characteristic that the second signal is spatially associated with the second RS resource comprises: the second signal and a radio signal received in the second RS resource use a same spatial reception parameter.

In one embodiment, the meaning of the characteristic that the second signal is spatially associated with the second RS resource comprises: the second signal and a radio signal received in the second RS resource adopt a same receiving spatial filtering.

In one embodiment, the meaning of the above characteristic that the second signal is spatially associated with the second RS resource comprises: the second signal and a radio signal received in the second

RS resource adopt a same receiving spatial filtering parameter.

In one embodiment, the meaning of the characteristic that the second signal is spatially associated with the second RS resource comprises: the second operation is to receive, and the second RS resource is used to determine a spatial filtering of the second signal.

In one embodiment, the meaning of the characteristic that the second signal is spatially associated with the second RS resource comprises: the second operation is to receive, and a radio signal received in the second RS resource is used to determine a spatial filtering of the second signal.

In one embodiment, the meaning of the characteristic that the second signal is spatially associated with the second RS resource comprises: the second operation is to transmit, and the second RS resource is used to determine a spatial filtering of the second signal.

In one embodiment, the meaning of the characteristic that the second signal is spatially associated with the second RS resource comprises: the second operation is to transmit, and a radio signal received in the second RS resource is used to determine a spatial filtering of the second signal.

In one embodiment, the meaning of the characteristic that the second signal is spatially associated with the second RS resource comprises: the second operation is to receive, and the second RS resource is used to determine a spatial receiving parameter of the second signal.

In one embodiment, the meaning of the characteristic that the second signal is spatially associated with the second RS resource comprises: the second operation is to receive, and a radio signal received in the second RS resource is used to determine a spatial reception parameter of the second signal.

In one embodiment, the meaning of the characteristic that the second signal is spatially associated with the second RS resource comprises: the second operation is to transmit, and the second RS resource is used to determine a spatial transmission parameter of the second signal.

In one embodiment, the meaning of the characteristic that the second signal is spatially associated with the second RS resource comprises: the second operation is to transmit, and a radio signal received in the second RS resource is used to determine a spatial transmission parameter of the second signal.

In one embodiment, the meaning of the characteristic that the second signal is spatially associated with the second RS resource comprises: the second operation is to receive, and a reception spatial filtering parameter of the second RS resource is used for a reception spatial filtering parameter of the second signal.

In one embodiment, the meaning of the characteristic that the second signal is spatially associated with the second RS resource comprises: the second operation is to receive, and a reception spatial filtering parameter of a radio signal received in the second RS resource is used for a reception spatial filtering parameter of the second signal.

In one embodiment, the meaning of the characteristic that the second signal is spatially associated with the second RS resource comprises: the second operation is to transmit, and a reception spatial filtering parameter of the second RS resource is used for a transmission spatial filtering parameter of the second signal.

In one embodiment, the meaning of the characteristic that the second signal is spatially associated with the second RS resource comprises: the second operation is to transmit, and a reception spatial filtering parameter of a radio signal received in the second RS resource is used for a transmission spatial filtering parameter of the second signal.

In one embodiment, the meaning of the characteristic that the second signal is spatially associated with the second RS resource comprises: the second operation is to receive, and the second RS resource is used to determine a DL RX Spatial Filter of the second signal.

In one embodiment, the meaning of the characteristic that the second signal is spatially associated with the second RS resource comprises: the second operation is to receive, and a radio signal received in the second RS resource is used to determine a DL RX Spatial Filter of the second signal.

In one embodiment, the meaning of the characteristic that the second signal is spatially associated with the second RS resource comprises: the second operation is to transmit, and the second RS resource is used to determine a UL TX Spatial Filter of the second signal.

In one embodiment, the meaning of the characteristic that the second signal is spatially associated with the second RS resource comprises: the second operation is to transmit, and a radio signal received in the second RS resource is used to determine a UL TX Spatial Filter of the second signal.

In one embodiment, the meaning of the characteristic that the second signal is spatially associated with the second RS resource comprises: the second operation is to receive, and the second node receives the second signal according to a spatial relation with reference to the second RS resource.

In one embodiment, the meaning of the characteristic that the second signal is spatially associated with the second RS resource comprises: the second operation is to receive, and the first node receives the second signal according to a spatial relation with reference to a radio signal received in the second RS resource.

In one embodiment, the meaning of the characteristic that the second signal is spatially associated with the second RS resource comprises: the second operation is to transmit, and the first node transmits the second signal according to a spatial relation with reference to the second RS resource.

In one embodiment, the meaning of the characteristic that the second signal is spatially associated with the second RS resource comprises: the second operation is to transmit, and the first node transmits the second signal according to a spatial relation with reference to a radio signal received in the second RS resource.

In one embodiment, the meaning of the characteristic that the second signal is spatially associated with the second RS resource comprises: the second operation is to receive, and PL determined for the second RS resource is used to determine PL of the second signal.

In one embodiment, the meaning of the characteristic that the second signal is spatially associated with the second RS resource comprises: the second operation is to receive, and PL determined for a radio signal received in the second RS resource is used to determine PL of the second signal.

In one embodiment, the meaning of the characteristic that the second signal is spatially associated with the second RS resource comprises: the second operation is to transmit, and PL determined for the second RS resource is used to determine a transmit power value of the second signal.

In one embodiment, the meaning of the characteristic that the second signal is spatially associated with the second RS resource comprises: the second operation is to transmit, and PL determined for a radio signal received in the second RS resource is used to determine a transmit power value of the second signal.

In one embodiment, the meaning of the characteristic that the second signal is spatially associated with the second RS resource comprises: the second operation is to transmit, and a measurement for the second RS resource is used to determine a transmit power value of the second signal.

In one embodiment, the meaning of the characteristic that the second signal is spatially associated with the second RS resource comprises: the second operation is to transmit, and a measurement for a radio signal received in the second RS resource is used to determine a transmit power value of the second signal.

In one embodiment, the meaning of the characteristic that the second signal is spatially associated with the second RS resource comprises: the second operation is to transmit, and a reception for a radio signal in the second RS resource is used to determine a downlink timing, and the downlink timing is used to determine a transmission timing of the second signal.

In one embodiment, a DMRS antenna port of the second signal and an antenna port of the second RS resource are QCLed.

In one embodiment, an antenna port adopted by the second signal and an antenna port of the second RS resource are QCLed.

In one embodiment, the second RS resource is an RS resource other than the first RS resource set in the present application.

In one embodiment, time-domain resources occupied by the second signal are not limited by the first time-domain resource pool.

In one embodiment, time-domain resources occupied by the second signal are not limited by the second time-domain resource pool.

In one embodiment, time-domain resources occupied by the second signal are independent of a configuration of the first time-domain resource pool.

In one embodiment, time-domain resources occupied by the second signal are independent of a configuration of the second time-domain resource pool.

In one embodiment, steps in box F91 in FIG. 9 exist and steps in box F92 in FIG. 9 do not exist; a method to be applied to the first node U9 in the present application includes: transmitting a second signal on a first frequency band.

In one subembodiment of the embodiment, the second signal is transmitted on an uplink physical control channel (i.e, an uplink channel capable of bearing a physical-layer signaling).

In one subembodiment of the embodiment, a physical-layer channel occupied by the second signal comprises a PUCCH.

In one subembodiment of the embodiment, the second signal is transmitted on an uplink physical data channel (i.e., an uplink channel capable of bearing physical-layer data).

In one subembodiment of the embodiment, a physical-layer channel occupied by the second signal comprises a PUSCH.

In one subembodiment of the embodiment, a physical-layer channel occupied by the second signal comprises a PRACH.

In one subembodiment of the embodiment, a transmission channel corresponding to the second signal comprises a UL-SCH.

In one subembodiment of the embodiment, a transmission channel corresponding to the second signal comprises an RACH.

In one subembodiment of the above embodiment, the step S990 is taken before the step S9910; the step S9100 is taken before the step S91010.

In one embodiment, steps in box F92 in FIG. 9 exist and steps in box F91 in FIG. 9 do not exist: a method to be applied to the first node U9 in the present application comprises: receiving a second signal on a first frequency band.

In one subembodiment of the embodiment, the second signal is transmitted on a downlink physical control channel (i.e, a downlink channel only capable of bearing a physical-layer signaling).

In one subembodiment of the embodiment, a physical-layer channel occupied by the second signal comprises a PDCCH.

In one subembodiment of the embodiment, the second signal is transmitted on a downlink physical data channel (i.e., a downlink channel capable of bearing physical-layer data).

In one subembodiment of the embodiment, a physical-layer channel occupied by the second signal comprises a PDSCH.

In one subembodiment of the embodiment, a transmission channel corresponding to the second signal comprises a DL-SCH.

In one subembodiment of the above embodiment, the step S990 is taken before the step S9920; the step S9100 is taken before the step S91020.

### Embodiment 10

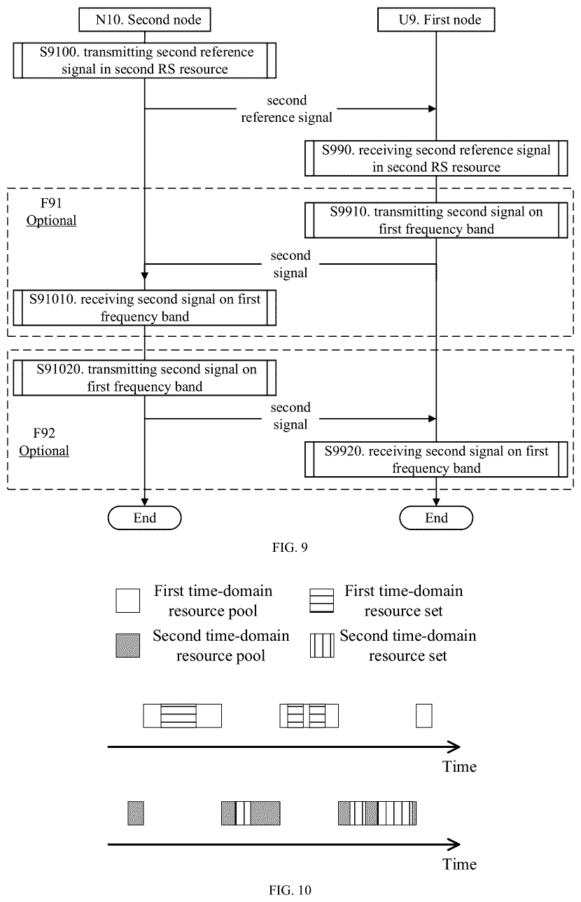

Embodiment 10 illustrates a schematic diagram of a first time-domain resource pool, a second time-domain resource pool, a first time-domain resource set and a second time-domain resource set according to one embodiment of the present application, as shown in FIG. 10. In FIG. 10, the area filled in white represents time-domain resources occupied by a first time-domain resource pool in time, the area filled in gray represents time-domain resources occupied by a second time-domain resource pool in time, and the area filled in horizontal lines represents time-domain resources occupied by a first time-domain resource set in time, and the area filled by the vertical lines represents time-domain resource occupied by a second time-domain resource set in time. It is worth noting that the drawings attached to this embodiment are illustrative only and represent a length of time-domain resources when actually implemented.

In embodiment 10, when the first operating is to receive, the time-domain resources occupied by the first signal belong to a second time-domain resource set; when the first operating is to transmit, the time-domain resources occupied by the first signal belong to a first time-domain resource set; the first time-domain resource pool comprises the first time-domain resource set, and the second time-domain resource pool comprises the second time-domain resource set.

In one embodiment, when the first operating is to receive, the time-domain resources occupied by the first signal belong to a second time-domain resource set; when the first operating is to transmit, the time-domain resources occupied by the first signal belong to a first time-domain resource set; the first time-domain resource pool comprises the first time-domain resource set, and the second time-domain resource pool comprises the second time-domain resource set.

In one embodiment, the first time-domain resource set comprises continuous time-domain resources.

In one embodiment, the first time-domain resource set comprises discontinuous time-domain resources.

In one embodiment, the first time-domain resource set comprises periodic time-domain resources.

In one embodiment, the first time-domain resource set comprises multiple subframes.

In one embodiment, the first time-domain resource set comprises multiple slots.

In one embodiment, the first time-domain resource set comprises multiple multicarrier symbols.

In one embodiment, the first time-domain resource set comprises continuous time-domain resources.

In one embodiment, the first time-domain resource set comprises discontinuous time-domain resources.

In one embodiment, the first time-domain resource set comprises periodic time-domain resources.

In one embodiment, the first time-domain resource set comprises multiple subframes.

In one embodiment, the second time-domain resource set comprise multiple slots.

In one embodiment, the second time-domain resource set comprises multiple multicarrier symbols.

In one embodiment, there at least exists one time resource only belonging to the first time-domain resource set, the time resource being one of slot, subframe or multicarrier symbol.

In one embodiment, there at least exists one time resource only belonging to the second time-domain resource set, the time resource being one of slot, subframe or multicarrier symbol.

In one embodiment, there at least exists one time unit only belonging to the first time-domain resource set, the time unit being slot, subframe or a duration of an OFDM symbol, etc.

In one subembodiment of the embodiment, there at least exists one time unit only belonging to the second time-domain resource set, the time unit being slot, subframe or a duration of an OFDM symbol, etc.

In one embodiment, there at least exists one time unit only belonging to the second time-domain resource set, the time unit being slot, subframe or a duration of an OFDM symbol.

In one subembodiment of the embodiment, there at least exists one time unit only belonging to the first time-domain resource set, the time unit being slot, subframe or a duration of an OFDM symbol, etc.

In one embodiment, the first time-domain resource set and the second time-domain resource set are orthogonal in time domain.

In one embodiment, the first time-domain resource set is configured through a higher-layer signaling.

In one embodiment, the second time-domain resource set is configured through a higher-layer signaling.

In one embodiment, the first time-domain resource set is a subset of the first time-domain resource pool.

In one embodiment, the second time-domain resource set is a subset of the second time-domain resource pool.

In one embodiment, the first time-domain resource set is equal to the first time-domain resource pool.

In one embodiment, the second time-domain resource set is equal to the second time-domain resource pool.

In one embodiment, the first time-domain resource set is a true subset of the first time-domain resource pool.

In one embodiment, the second time-domain resource set is a true subset of the second time-domain resource pool.

In one embodiment, any time-domain resource comprised in the first time-domain resource set belongs to the first time-domain resource pool, and at least one time-domain resource comprised in the first time-domain resource pool does not belong to the first time-domain resource set.

In one embodiment, any time-domain resource comprised in the second time-domain resource set belongs to the second time-domain resource pool, and at least one time-domain resource comprised in the second time-domain resource pool does not belong to the second time-domain resource set.

### Embodiment 11

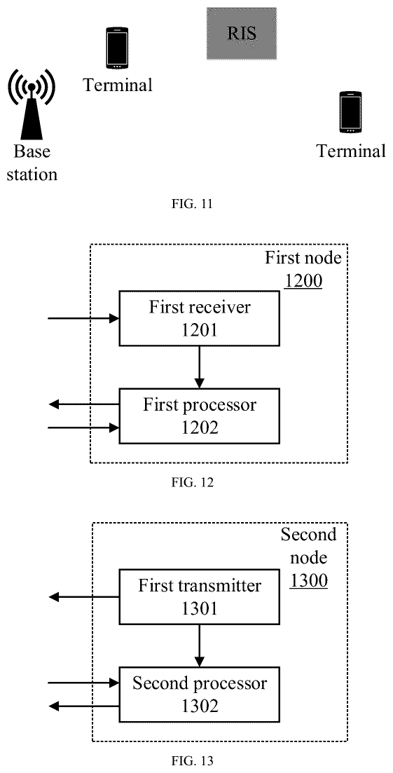

Embodiment 11 illustrates a schematic diagram of an intelligent surface according to one embodiment of the present application, as shown in FIG. 11. In FIG. 11, the RIS refers to: Reconfigurable Intelligent Surface; the base station comprises the second node in the present application; the terminal comprises the first node in the present application.

In one embodiment, a transmission path of a reference signal transmitted in the first RS resource comprises a link composed of an incident link from a base station to RIS and a reflected link from RIS to a terminal.

In one embodiment, a transmission path of a reference signal transmitted in any RS resource in the first RS resource set comprises a link composed of an incident link from a base station to RIS and a reflected link from RIS to a terminal.

In one embodiment, a transmission path for any RS resource outside the first RS resource set comprises a direct link from a base station to a terminal.

In one embodiment, the first operating is to receive, only when the first RS resource is an RS resource in the first RS resource set, a transmission path of the first signal comprises a link composed of an incident link from a base station to RIS and a reflected link from RIS to a terminal.

In one embodiment, the first operating is to transmit, only when the first RS resource is an RS resource in the first RS resource set, a transmission path of the first signal comprises a link composed of an incident link from a terminal to RIS and a reflected link from RIS to a base station.

### Embodiment 12

Embodiment 12 illustrates a structure block diagram of a processor in a first node according to one

embodiment of the present application, as shown in FIG. 12. In FIG. 12, a processor 1200 in a first node comprises a first receiver 1201 and a first processor 1202.

In embodiment 12, the first receiver 1201 receives a first reference signal in a first RS resource; the first processor 1202 operates a first signal firstly on a first frequency band.

In embodiment 12, a duplex mode of the first frequency band is a frequency division duplex; the first operating is to receive and the first signal is on a downlink working band, or the first operating is to transmit and the first signal is on an uplink working band; the first signal is spatially associated with the first RS resource; when the first operating is to receive, time-domain resources occupied by the first signal are not overlapping with a first time-domain resource pool; when the first operating is to transmit, time-domain resources occupied by the first signal are not overlapping with a second time-domain resource pool; time-domain resources occupied by the first time-domain resource pool are orthogonal to time-domain resources occupied by the second time-domain resource pool.

In one embodiment, the first receiver 1201 receives a first signaling, and the first signaling indicates a first RS resource set; only when the first RS resource is an RS resource in the first RS resource set, the first time-domain resource pool and the second time-domain resource pool are applied.

In one embodiment, when the first operating is to receive, the time-domain resources occupied by the first signal belong to a second time-domain resource set; when the first operating is to transmit, the time-domain resources occupied by the first signal belong to a first time-domain resource set; the first time-domain resource pool comprises the first time-domain resource set, and the second time-domain resource pool comprises the second time-domain resource set.

In one embodiment, the first receiver 1201 receives a second signaling; the second signaling is used to configure the first time-domain resource set and the second time-domain resource set.

In one embodiment, the first receiver 1201 receives a third signaling; the third signaling is used to configure the first time-domain resource set and the second time-domain resource set, the second signaling is a higher-layer signaling, and the third signaling is a physical-layer signaling.

In one embodiment, the first receiver 1201 receives a fourth signaling; the fourth signaling is used to configure the first time-domain resource pool and the second time-domain resource pool.

In one embodiment, the first receiver 1201 receives a second reference signal in a second RS resource; the first processor 1202 operates a second signal secondly on the first frequency band; the second operating is to receive and the second signal is on a downlink working band, or the second operating is to transmit and the second signal is on an uplink working band; the second signal is spatially associated with the second RS resource; the first time-domain resource pool and the second time-domain resource pool are not applied to the second RS resource.

In one embodiment, the first operating is to transmit, and the first reference signal received in the first RS resource is used for at least one of a timing advance of the first signal, a spatial filtering of the first signal, or a calculation of transmit power of the first signal; the first operating is to receive, and the first reference signal received in the first RS resource is used for at least one of the first signal downlink timing, a spatial filtering of the first signal, or a pathloss calculation of the first signal.

In one embodiment, the second signaling and the fourth signaling belong to two different fields in a same RRC IE; the RRC IE comprises ServingCellConfigCommon IE.

In one embodiment, the first signaling, the second signaling, and the fourth signaling respectively belong to three different fields in a same RRC IE, and the RRC IE comprises ServingCellConfigCommon IE.

In one embodiment, at least one of the first time-domain resource pool or the second time-domain resource pool is associated with the first RS resource set.

In one embodiment, there does not exist a time resource not belonging to time-domain resources occupied by the first time-domain resource pool and not belonging to time-domain resources occupied by the second time-domain resource pool, the time resource being one of slot, subframe, or multicarrier symbol.

In one embodiment, there exists at least one time resource not belonging to time-domain resources occupied by the first time-domain resource pool and not belonging to time-domain resources occupied by the second time-domain resource pool, the time resource being one of slot, subframe, or multicarrier symbol.

In one embodiment, the first node is a UE.

In one embodiment, the first node is a relay node.

In one embodiment, the first receiver 1201 comprises at least one of the antenna 452, the receiver 454, the receiving processor 456, the multi-antenna receiving processor 458, the controller/processor 459, the memory 460, or the data source 467 in embodiment 4.

In one embodiment, the first processor 1202 comprises at least one of the antenna 452, the transmitter 454, the transmitting processor 468, the receiving processor 456, the multi-antenna transmitting processor 457, the multi-antenna receiving processor 458, the controller/processor 459, the memory 460, and the data source 467 in Embodiment 4.

### Embodiment 13

Embodiment 13 illustrates a structure block diagram of a processor in a second node according to one embodiment of the present application, as shown in FIG. 13. In FIG. 13, a processor 1300 in a second node comprises a first transmitter 1301 and a second processor 1302.

In Embodiment 13, the first transmitter 1301 transmits a first reference signal in a first RS resource; the second processor 1302 operates a first signal thirdly on a first frequency band.

In embodiment 13, a duplex mode of the first frequency band is a frequency division duplex; the third operating is to transmit and the first signal is on a downlink working band, or the third operating is to receive and the first signal is on an uplink working band; the first signal is spatially associated with the first RS resource; when the third operating is to transmit, time-domain resources occupied by the first signal are not overlapping with a first time-domain resource pool; when the third operating is to receive, time-domain resources occupied by the first signal are not overlapping with a second time-domain resource pool; time-domain resources occupied by the first time-domain resource pool are orthogonal to time-domain resources occupied by the second time-domain resource pool.

In one embodiment, the first transmitter 1301 transmits a first signaling, and the first signaling indicates a first RS resource set; only when the first RS resource is an RS resource in the first RS resource set, the first time-domain resource pool and the second time-domain resource pool are applied.

In one embodiment, when the third operating is to transmit, the time-domain resources occupied by the first signal belong to a second time-domain resource set; when the third operating is to receive, the time-domain resources occupied by the first signal belong to a first time-domain resource set; the first time-domain resource pool comprises the first time-domain resource set, and the second time-domain resource pool comprises the second time-domain resource set.

In one embodiment, the first transmitter 1301 transmits a second signaling; the second signaling is used to configure the first time-domain resource set and the second time-domain resource set.

In one embodiment, the first transmitter 1301 transmits a third signaling; the third signaling is used to configure the first time-domain resource set and the second time-domain resource set, the second signaling is a higher-layer signaling, and the third signaling is a physical-layer signaling.

In one embodiment, the first transmitter 1301 transmits a fourth signaling; the fourth signaling is used to configure the first time-domain resource pool and the second time-domain resource pool.

In one embodiment, the first transmitter 1301 transmits a second reference signal in a second RS resource; the second processor 1302 operates a second signal fourthly on the first frequency band; the fourth operation is to transmit and the second signal is on a downlink working band, or the fourth operation is to receive and the second signal is on an uplink working band; the second signal is spatially associated with the second RS resource; the first time-domain resource pool and the second time-domain resource pool are not applied to the second RS resource.

In one embodiment, the third operation is to receive, and the first reference signal received in the first RS resource is used for at least one of a timing advance of the first signal, a spatial filtering of the first signal, or a calculation of transmit power of the first signal; the third operation is to transmit, and the first reference signal received in the first RS resource is used for at least one of the first signal downlink timing, a spatial filtering of the first signal, or a pathloss calculation of the first signal.

In one embodiment, the second signaling and the fourth signaling belong to two different fields in a same RRC IE; the RRC IE comprises ServingCellConfigCommon IE.

In one embodiment, the first signaling, the second signaling, and the fourth signaling respectively belong to three different fields in a same RRC IE, and the RRC IE comprises ServingCellConfigCommon IE.

In one embodiment, at least one of the first time-domain resource pool or the second time-domain resource pool is associated with the first RS resource set.

In one embodiment, there does not exist a time resource not belonging to time-domain resources occupied by the first time-domain resource pool and not belonging to time-domain resources occupied by the second time-domain resource pool, the time resource being one of slot, subframe, or multicarrier symbol.

In one embodiment, there exists at least one time resource not belonging to time-domain resources occupied by the first time-domain resource pool and not belonging to time-domain resources occupied by the second time-domain resource pool, the time resource being one of slot, subframe, or multicarrier symbol.

In one embodiment, the second node is a base station.

In one embodiment, the second node is a UE.

In one embodiment, the second node is a relay node.

In one embodiment, the second node is a maintenance device for a serving cell.

In one embodiment, the second node is a serving cell maintenance device of the first node.

In one embodiment, the first transmitter 1301 comprises at least one of the antenna 420, the transmitter 418, the transmitting processor 416, the multi-antenna transmitting processor 471, the controller/processor 475, or the memory 476 in Embodiment 4.

In one embodiment, the second processor 1302 comprises at least one of the antenna 420, the receiver/transmitter 418, the receiving processor 470, the transmitting processor 416, the multi-antenna receiving processor 472, the multi-antenna transmitting processor 471, the controller/processor 475, or the memory 476 in Embodiment 4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, telecontrolled aircrafts, aircrafts, diminutive airplanes, mobile phones, tablet computers, notebooks, vehicle-mounted communication equipment, vehicles, cars, RSUs, wireless sensors, network cards, Internet of Things (IOT) terminals, RFID (Radio Frequency Identification) terminals, NB-IOT (Narrow Band Internet of Things) terminals, Machine Type Communication (MTC) terminals, enhanced MTC (eMTC) terminals, data card, network cards, vehicle-mounted communication equipment, low-cost mobile phones, low-cost tablets and other wireless communication devices.

The base stations or system equipment in the present application include, but are not limited to, macro cellular base stations, micro cellular base stations, small cellular base stations, home base stations, relay base stations, eNB (evolved Node B), gNB, TRP, GNSS (Global Navigation Satellite System), relay satellites, satellite base stations, aerial base stations, RSUs, Unmanned Aerial Vehicles (UAVs), test equipment, such as transceiver units that simulate some of the functions of a base station or wireless communication equipment such as signaling testers.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first reference signal in a first RS resource; and
a first processor, first operating a first signal on a first frequency band;
wherein a duplex mode of the first frequency band is a frequency division duplex; the first operating is to receive and the first signal is on a downlink working band, or the first operating is to transmit and the first signal is on an uplink working band; the first signal is spatially associated with the first RS resource; when the first operating is to receive, time-domain resources occupied by the first signal are not overlapping with a first time-domain resource pool; when the first operating is to transmit, time-domain resources occupied by the first signal are not overlapping with a second time-domain resource pool; time-domain resources occupied by the first time-domain resource pool are orthogonal to time-domain resources occupied by the second time-domain resource pool.

2. The first node according to claim 1, comprising:
the first receiver, receiving a first signaling, the first signaling indicating a first RS resource set;
wherein only when the first RS resource is an RS resource in the first RS resource set, the first time-domain resource pool and the second time-domain resource pool are applied.

3. The first node according to claim 1, wherein when the first operating is to receive, the time-domain resources occupied by the first signal belong to a second time-domain resource set; when the first operating is to transmit, the time-domain resources occupied by the first signal belong to a first time-domain resource set; the first time-domain resource pool comprises the first time-domain resource set, and the second time-domain resource pool comprises the second time-domain resource set.

4. The first node according to claim 3, comprising:
the first receiver, receiving a second signaling;
wherein the second signaling is used to configure the first time-domain resource set and the second time-domain resource set.

5. The first node according to claim 4, comprising:
the first receiver, receiving a third signaling:
wherein the third signaling is used to configure the first time-domain resource set and the second time-domain resource set, the second signaling is a higher-layer signaling, and the third signaling is a physical-layer signaling.

6. The first node according to claim 1, comprising:
the first receiver, receiving a fourth signaling;
wherein the fourth signaling is used to configure the first time-domain resource pool and the second time-domain resource pool.

7. The first node according to claim 1, comprising:
the first receiver, receiving a second reference signal in a second RS resource; and
the first processor, second operating a second signal on the first frequency band;
wherein the second operating is to receive and the second signal is on a downlink working band, or the second operating is to transmit and the second signal is on an uplink working band; the second signal is spatially associated with the second RS resource; the first time-domain resource pool and the second time-domain resource pool are not applied to the second RS resource.

8. The first node according to claim 1, wherein the first time-domain resource pool is not used for downlink transmission, and the second time-domain resource pool is not used for uplink transmission.

9. The first node according to claim 1, wherein the first RS resource is a CSI-RS resource, or the first RS resource corresponds to an SSB-Index.

10. The first node according to claim 1, wherein the first frequency band corresponds to an Active BWP.

11. The first node according to claim 1, wherein the meaning that the first signal is spatially associated with the first RS resource comprises: the first operating is to receive, and the first RS resource is used to determine spatial reception parameters of the first signal.

12. The first node according to claim 1, wherein the meaning that the first signal is spatially associated with the first RS resource comprises: the first signal and the first RS resource are QCLed.

13. The first node according to claim 1, wherein the meaning that the first signal is spatially associated with the first RS resource comprises: the first operating is to transmit, and a measurement for a radio signal in the first RS resource is used to determine a transmit power value of the first signal.

14. The first node according to claim 1, wherein the meaning that the first signal is spatially associated with the first RS resource comprises: the first operating is to transmit, and the first RS resource is used to determine spatial transmission parameters of the first signal.

15. A second node for wireless communications, comprising:
a first transmitter, transmitting a first reference signal in a first RS resource; and
a second processor, third operating a first signal on a first frequency band;
wherein a duplex mode of the first frequency band is a frequency division duplex; the third operating is to transmit and the first signal is on a downlink working band, or the third operating is to receive and the first signal is on an uplink working band; the first signal is spatially associated with the first RS resource; when the third operating is to transmit, time-domain resources occupied by the first signal are not overlapping with a first time-domain resource pool; when the third operating is to receive, time-domain resources occupied by the first signal are not overlapping with a second time-domain resource pool; time-domain resources occupied by the first time-domain resource pool are orthogonal to time-domain resources occupied by the second time-domain resource pool.

16. The second node according to claim 15, comprising:
the first transmitter, transmitting a first signaling, the first signaling indicating a first RS resource set;
wherein only when the first RS resource is an RS resource in the first RS resource set, the first time-domain resource pool and the second time-domain resource pool are applied.

17. The second node according to claim 15, wherein when the third operating is to transmit, the time-domain resources occupied by the first signal belong to a second time-domain resource set; when the third operating is to receive, the time-domain resources occupied by the first signal belong to a first time-domain resource set; the first time-domain resource pool comprises the first time-domain resource set, and the second time-domain resource pool comprises the second time-domain resource set.

18. The second node according to claim 17, comprising:
the first transmitter, transmitting a second signaling;
wherein the second signaling is used to configure the first time-domain resource set and the second time-domain resource set.

19. The second node according to claim 18, comprising:
the first transmitter, transmitting a third signaling;
wherein the third signaling is used to configure the first time-domain resource set and the second time-domain resource set, the second signaling is a higher-layer signaling, and the third signaling is a physical-layer signaling.

20. A method in a first node for wireless communications, comprising:
receiving a first reference signal in a first RS resource; and
first operating a first signal on a first frequency band;
wherein a duplex mode of the first frequency band is a frequency division duplex; the first operating is to receive and the first signal is on a downlink working band, or the first operating is to transmit and the first signal is on an uplink working band; the first signal is spatially associated with the first RS resource; when the first operating is to receive, time-domain resources occupied by the first signal are not overlapping with a first time-domain resource pool; when the first operating is to transmit, time-domain resources occupied by the first signal are not overlapping with a second time-domain resource pool; time-domain resources occupied by the first time-domain resource pool are orthogonal to time-domain resources occupied by the second time-domain resource pool.
